(19) United States
(12) Patent Application Publication
(10) Pub. No.: US 2019/0190373 A1
(43) Pub. Date: Jun. 20, 2019

(54) Multi Output Three Level Buck Converter

(71) Applicant: Apple Inc., Cupertino, CA (US)

(72) Inventor: Michael B. Nussbaum, Santa Cruz, CA (US)

(21) Appl. No.: 15/887,593

(22) Filed: Feb. 2, 2018

Related U.S. Application Data
(60) Provisional application No. 62/607,673, filed on Dec. 19, 2017.

(51) Int. Cl. H02M 3/07

(52) U.S. Cl. CPC H02M 3/07

(57) ABSTRACT

A power converter can include a charge pump that receives an input voltage and generates a flying rail voltage therefrom and a plurality of buck converters configured to generate regulated voltages from the flying rail voltage. A symmetric controller can have an outer control loop configured to regulate the flying rail voltage and a plurality of inner control loops in communication with the outer control loop and configured to control the plurality of buck converters to generate regulated output voltages responsive to one or more signals received from the outer control loop. The outer loop can be configured to include a hysteretic controller. The outer control loop can be further configured to provide a signal to the plurality of inner control loops indicating whether the inner control loops should control respective buck converters to charge or discharge a capacitor supporting the flying rail voltage.

### BACKGROUND

Electronic devices continue their trend of becoming smaller, yet more computationally powerful. As a result, many existing power conversion solutions may be unable to provide desired levels of electrical power within acceptable size constraints. For example, in some devices, the power management integrated circuit (PMIC) and associated passive energy storage components (inductors and/or capacitors) may take up a substantial fraction of the entire device's area and/or volume. The traditional buck converter topologies that are included in a wide variety of electronic devices rely on inductors for energy storage. However, present passive device construction and materials technologies are such that capacitors can have much higher energy densities than inductors. This has led to interest in power conversion topologies that combine capacitor-based charge pumps with inductive topologies. An advantage of such combinations is that they can allow for “soft charging” of the capacitors in the charge pump, eliminating the ½CdV² losses and allowing for use of smaller capacitors than might be required in a traditional charge pump. Another advantage of such combinations is more precise output voltage regulation and improved efficiency beyond what is available with traditional charge pump arrangements.

Thus, there is a need for improved power conversion circuits that combine charge pumps with magnetic converters to provide desired power levels with reduced density and increased operating efficiency.

### SUMMARY

One embodiment disclosed herein is a power converter including a charge pump configured to receive an input voltage and generate a flying rail voltage therefrom and a plurality of buck converters each configured to generate a regulated output voltage from the flying rail voltage. The power converter can include an asymmetric controller, the asymmetric controller having a first controller coupled to the charge pump and a first buck converter and configured to control the flying rail voltage and the regulated output voltage of the first buck converter. The asymmetric controller can also include a second controller coupled to a second of the plurality of buck converters, wherein the second control loop is configured to control the regulated output voltage of the second buck converter. The first controller can be a constant on time pulse frequency modulation controller. The power converter can alternatively include a symmetric controller, the symmetric controller having an outer control loop configured to regulate the flying rail voltage and a plurality of inner control loops in communication with the outer control loop. Each inner control loop can be configured to control one of the plurality of buck converters to generate a respective regulated output voltage responsive to one or more signals received from the outer control loop. The outer loop can be configured to regulate the flying rail voltage using a hysteretic controller configured to provide a signal to the plurality of inner control loops indicating whether the inner control loops should control respective buck converters to charge or discharge a capacitor supporting the flying rail voltage.

In the power converter described above, the charge pump can include a first charge pump switching device having first and second terminals, the first terminal of the first charge pump switching device being coupled to a first input voltage rail of the power converter. The charge pump can also include a second charge pump switching device having first and second terminals, the second terminal of the second charge pump switching device being coupled to a second input voltage rail of the power converter. The charge pump can also include a flying capacitor having a first flying capacitor terminal coupled to the second terminal of the first charge pump switching device and a second flying capacitor terminal coupled to the first terminal of the second charge pump switching device, wherein a voltage across the flying capacitor is the flying rail voltage. In such a converter, each of the plurality of buck converters can include a first buck converter switching device having first and second terminals, the first terminal of the first buck converter switching device being coupled to the first flying capacitor terminal. The buck converters can also include a second buck converter switching device having first and second terminals, the second terminal of the second buck converter switching device being coupled to the second flying capacitor terminal. The buck converter can also include an inductor having a first inductor terminal coupled to the second terminal of the first buck converters switching device and the first terminal of the second buck converter switching device and a second inductor terminal coupled to an output terminal.

In another embodiment, a power converter can include two charge pumps, a first charge pump coupled between an input of the power converter and a first pair of flying rails and configured to generate a first flying rail voltage across the first pair of flying rails, and second charge pump coupled between the first pair of flying rails and a second pair of flying rails and configured to generate a second flying rail voltage across the second pair of flying rails. Such a converter can have at least one buck converter coupled between the first pair of flying rails and configured to generate a first regulated output voltage from the first flying rail voltage, and at least one buck converter coupled between the second pair of flying rails and configured to generate a second regulated output voltage from the second flying rail voltage. The two charge pump converter can include a first controller configured to control the first charge pump and the at least one buck converter coupled between the first pair of flying rails and a second controller configured to control the second charge pump and the at least one buck converter coupled between the second pair of flying rails. One or both of the first and second controllers can be configured to operate at least one corresponding buck converter in a continuous conduction mode. Additionally, the first and second controllers can be implemented as a single controller.

Another embodiment disclosed herein relates to a method of generating a plurality of output voltages from an input voltage. The method can include using a charge pump to generate a flying rail voltage from the input voltage and using a plurality of buck converters to convert the flying rail voltage to the plurality of output voltages. Using the charge pump to generate a flying rail voltage from the input voltage can include operating a hysteretic controller to generate control signals sent to the buck converters indicating whether they charge or discharge the charge pump's capacitor. Using a plurality of buck converters to convert the flying rail voltage to the plurality of output voltages can include operating the plurality of buck converters responsive to one or more signals received from an outer loop controller of the charge pump indicating whether the plurality of buck converters are to charge or discharge a capacitor of the charge pump. Using a plurality of buck converters to convert the flying rail voltage to the plurality of output voltages can also include the use of a predictive control algorithm.

In still another embodiment, using a charge pump to generate a flying rail voltage from the input voltage can include using a first charge pump to generate a first flying rail voltage from the input voltage and using a second charge pump to generate a second flying rail voltage from the first flying rail voltage. In the same or other embodiments, using a plurality of buck converters to convert the flying rail voltage to the plurality of output voltages can include using at least one buck converter to convert the first flying rail voltage to a first regulated output voltage and using at least one buck converter to convert the second flying rail voltage to a second regulated output voltage.

Yet another embodiment relates to a controller for a power converter having a charge pump and a plurality of buck converters. The charge pump can be configured to receive an input voltage and generate a flying rail voltage therefrom. The plurality of buck converters can each being configured to receive the flying rail voltage and generate a regulated output voltage therefrom. The controller can include an outer control loop configured to regulate the flying rail voltage by generating a signal sent to the buck converters. The controller can also include a plurality of inner control loops in communication with the outer control loop, each configured to control a plurality of switches coupled between the flying rails to generate a respective regulated output voltages responsive to the one or more signals received from the outer control loop. The outer loop can include a hysteretic controller configured to provide a signal to the plurality of inner control loops indicating whether the inner control loops should control respective buck converters to charge or discharge a capacitor supporting the flying rail voltage.

Still another embodiment relates to a controller for a power converter having a first charge pump, at least one buck converter coupled to the output of the first charge pump, a second charge pump coupled to the output of the first charge pump, and at least one buck converter coupled to the output of the second charge pump. The controller can include a first controller configured to operate the first charge pump and the at least one buck converter coupled to the output of the first charge pump to generate a regulated output voltage at an output of each of the at least one buck converters coupled to the output of the first charge pump. The controller can also include a second controller configured to operate the second charge pump and the at least one buck converter coupled to the output of the second charge pump to generate a regulated output voltage at an output of each of the at least one buck converters coupled to the output of the second charge pump. At least one of the first and second controllers may be configured to operate at least one corresponding buck converter in a continuous conduction mode. Additionally, the first and second controllers may be implemented as a single controller.

### BRIEF DESCRIPTION OF THE DRAWINGS

FIG. 1 depicts a schematic of a three level buck converter.

FIG. 2 depicts the switching stages of a three level buck converter.

FIG. 3 depicts a schematic of a multi output three level buck converter.

FIG. 4 depicts a schematic of a multi output three level buck converter with asymmetric control.

FIG. 5 depicts a schematic of a multi output three level buck converter with symmetric control.

FIG. 6 depicts a block diagram of a multi output three level buck converter with symmetric control.

FIG. 7 depicts waveforms associated with a charge pump of a multi output three level buck converter.

FIG. 8A depicts a state diagram of a buck converter controller for use with a symmetric controller of a multi output three level buck converter.

FIG. 8B depicts various switching states of a three level buck converter operated by symmetric controller.

FIG. 9 depicts buck converter waveforms of a multi output three level buck converter corresponding to Case A in FIG. 8B.

FIG. 10 depicts buck converter waveforms of a multi output three level buck converter corresponding to Case B in FIG. 8B.

FIG. 11 depicts buck converter waveforms of a multi output three level buck converter corresponding to Case C in FIG. 8B.

FIG. 12 depicts buck converter waveforms of a multi output three level buck converter corresponding to Case D in FIG. 8B.

FIG. 13 depicts a schematic diagram of a multi output three level buck converter having a second charge pump.

FIG. 14 depicts a clock generation technique for a multi output three level buck converter having a second charge pump and symmetric control in which all buck converters operate in discontinuous conduction mode.

FIG. 15 depicts a block diagram of a second charge pump controller of a symmetric controller for a multi output three level buck converter having a second charge pump and symmetric control in which all buck converters operate in discontinuous conduction mode.

FIG. 16A depicts a state diagram of a controller for a first charge pump and a CCM buck converter coupled to the output thereof.

FIG. 16B depicts a state diagram of a controller for a second charge pump coupled to the output of the first charge pump and a CCM buck converter coupled to the output of the second charge pump.

FIG. 17 depicts a series of logic circuits for generating the gate drive signals for the various switches of a multi output three level buck converter having a second charge pump.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

### Three Level Buck Converter Topology and Operation

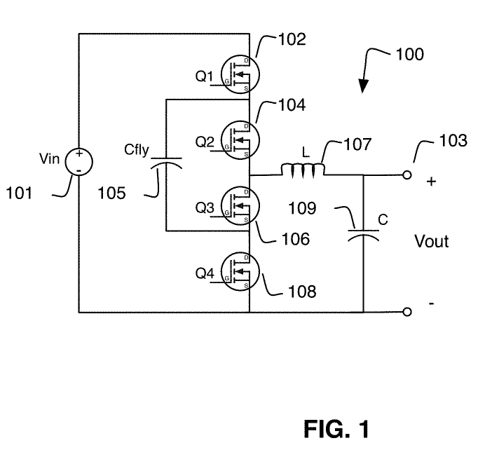

A three level buck converter 100 is illustrated in FIG. 1. Three level buck converter 100 receives a DC input voltage 101 and converts it to a regulated output voltage Vout at output terminals 103. Three level buck converter can include a ladder of four switching devices 102, 104, 106, 108 connected across the input voltage rails. The switching devices may be transistors, such as field effect transistors (FETs), metal-oxide semiconductor field effect transistors (MOSFETs), junction field effect transistors (JFETs), insulated gate bipolar transistors (IGBTs), or other types of switching devices. A flying capacitor 105 may be connected between the junction of first and second switches 102, 104 and the junction of third and fourth switches 106, 108. An inductor 107 may be connected between the junction of second and third switches 104, 106 and positive output terminal 103. A capacitor 109 may be connected across output terminals 103.

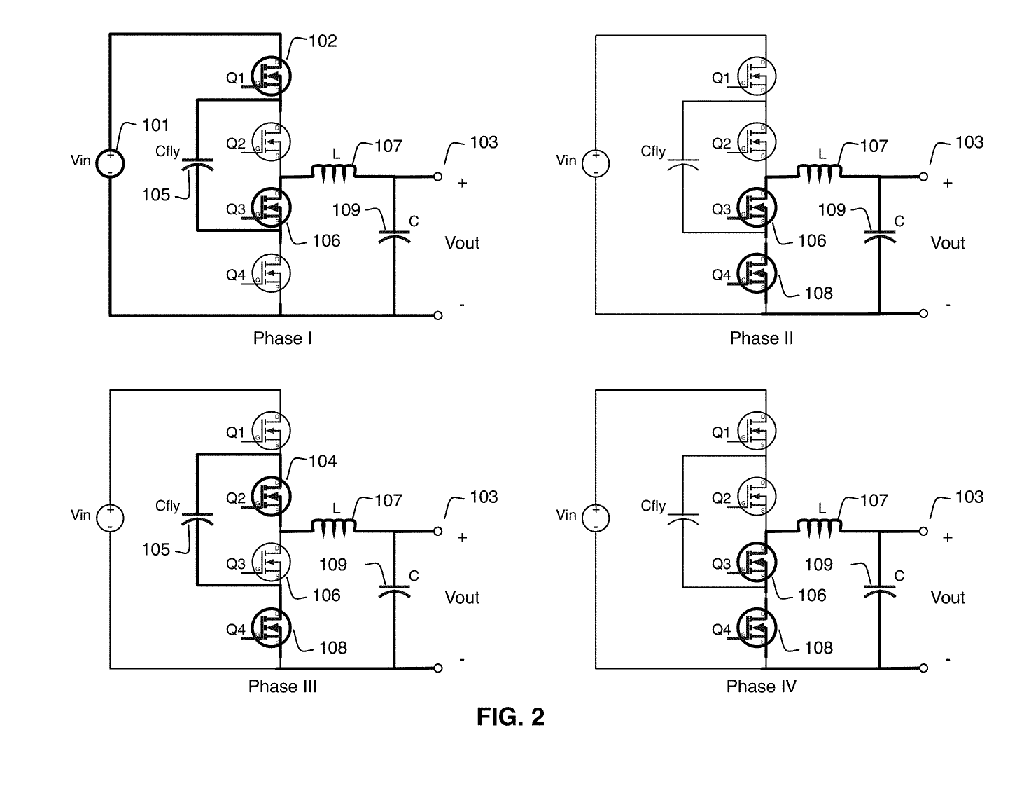

FIG. 2 illustrates at a high level the four phases of operation of a three level buck converter. In Phase I, first and third switches 102 and 106 are turned on, while second and fourth switches 104 and 108 are turned off. This causes current to flow from input voltage source 101, through first switch 102, flying capacitor 105, and third switch 106, thereby charging flying capacitor 105. Current also flows thence through inductor 107 to charge output capacitor 109 and deliver power to a load connected across output terminals 103.

In Phase II, third and fourth switches 106 and 108 are turned on, while first and second switches 102 and 104 are turned off. Because the current flowing through inductor 107 cannot change instantaneously, current continues to flow through inductor 107. A load connected across output terminals 103 continues to receive power from inductor 107 and output capacitor 109. Current returns to inductor 107 through third and fourth switches 106 and 108. In other words, during Phase II, the circuit behaves like a synchronous buck converter. Charge on the flying capacitor 105 does not change during Phase II.

In Phase III, energy stored in flying capacitor 105 is delivered to the load. Second and fourth switches 104 and 108 are closed, providing a path for current to flow from flying capacitor 105, through second switch 104 and inductor 107, to output capacitor 109 and/or the load connected between output terminals 103. Thus current recharges output capacitor 109 and delivers power to the load. Current returns to flying capacitor 105 via fourth switch 108.

Phase IV is similar to Phase II. Third and fourth switches 106 and 108 are turned on, while first and second switches 102 and 104 are turned off. Because the current flowing through inductor 107 cannot change instantaneously, current continues to flow through inductor 107. A load connected across output terminals 103 continues to receive power from inductor 107 and output capacitor 109. Current returns to inductor 107 through third and fourth switches 106 and 108. Charge on the flying capacitor 105 does not change during Phase IV.

It will be appreciated that flying capacitor 105 is not fully discharged (i.e., to 0V) during operation of the circuit. Rather, the circuit may be controlled so that the voltage of the flying capacitor remains at approximately some fraction of the input voltage Vin. For example, the circuit described above may be controlled to maintain flying capacitor 105 at approximately ½Vin. The instantaneous voltage across flying capacitor 105 will actually increase slightly above ½Vin during charging and decrease slightly below ½Vin during discharging. The magnitude of these voltage excursions above and below Vin are parameters that may be selected by a system designer to meet various performance objectives of the system. These performance objectives can include voltage ripple as the input voltage traverses the region of 2*Vout, and the frequency at which the system changes from charging to discharging the flying capacitor.

Use of an up-front charge pump to create a rail having a voltage equal to ½Vin provides various advantages with respect to the circuit components used to construct the converter. First, it will be appreciated that inductor energy storage, and therefore inductor size, increases proportionally to the square of the inductor flux (i.e., B²). Inductor flux (B) is proportional to the applied voltage (i.e., ½Vin-Vout for Phases I and III) and Vout for Phases II and IV) times the amount of time (T) that current is driven into the inductor. Thus, by reducing the voltage applied to the inductor from Vin to ½Vin, smaller inductors may be used for any given switching frequency. Additionally, the switching devices need only be rated at ½Vin rather than Vin. In some applications this can allow for implementation with smaller, faster, lower voltage CMOS devices. This can, in some embodiments, mitigate the disadvantages of requiring two such switches in series, as compared to only one in a traditional buck converter topology.

### Multi Output Three Level Buck Converter Topology

In some applications, it may be desirable to use the three level buck converter topology to provide a multiplicity of regulated output voltages. As an example, suppose that one wished to provide four regulated output voltages using this topology. One approach to such applications would be to implement four separate three level buck converters. For some applications, this approach may be undesirable because it would require sixteen switching devices and four flying capacitors and the associated routing on and off the chip as well as an inductor and capacitor for each output. Even in fairly low power applications, where the switching devices can be integrated into the same silicon as the controller, the additional flying capacitors and interconnect may increase the required volume beyond that which is available for a given design. Thus, it would be desirable to provide a single input charge pump stage that drives a plurality output buck stages.

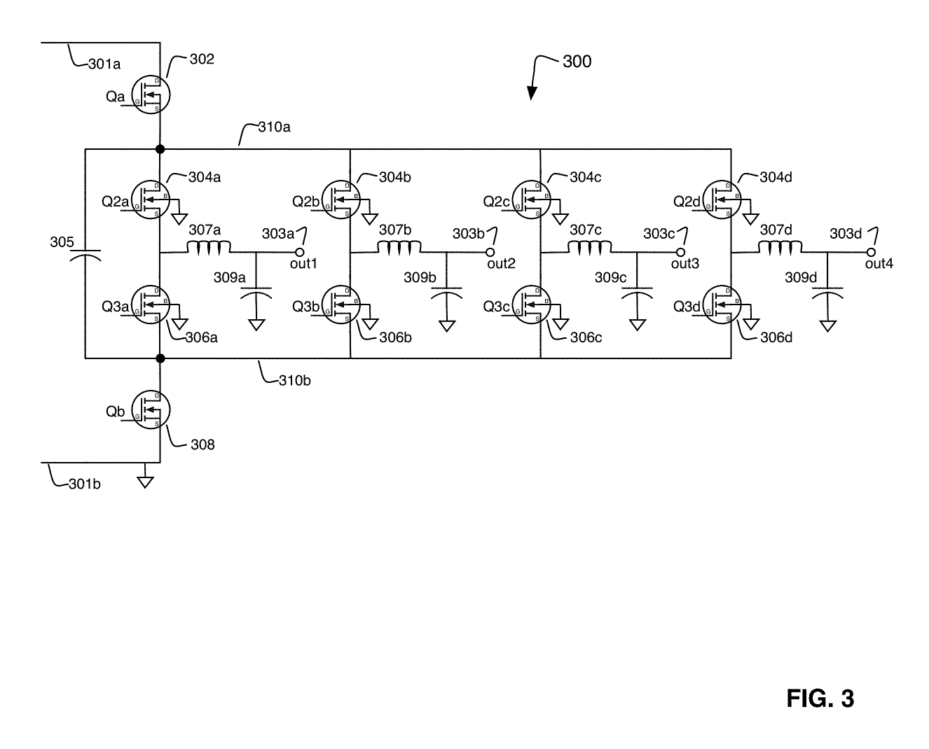

FIG. 3 illustrates a multi output three level buck converter having a single input charge pump stage driving a plurality of output buck stages. A DC input voltage may be applied to input rails 301a and 301b. Charge pump switches Qa (302) and Qb (308) may be operated to charge and discharge flying capacitor 305, which supports charge pump flying rails 310a and 310b. A plurality of buck converters may be connected to these flying rails. In the illustrated embodiment, four buck converters are provided, although more or fewer such buck converters may be provided.

Each buck converter receives its input voltage from flying rails 310a and 310b and produces a regulated output voltage at its output (303a-303d) by operating their high switches Q2a-Q2d (304a-304d) and low side switches Q3a-Q3d (306a-306d) as described in greater detail below. High side switches Q2a-Q2d (304a-304d) are configured with their drain terminals coupled to the high flying rail 310a and their source terminals coupled to the drain terminals of low side switches Q3a-Q3d (306a-306d), respectively. Low side switches Q3a-Q3d (306a-306d) are configured with their drain terminals coupled to the source terminals of high side switches Q2a-Q2d (304a-304d), respectively, and their source terminals coupled to low flying rail 310b. For each buck converter, the junction point of the high side switch's source terminal and the low side switch's drain terminal is coupled to a first terminal of inductor 307a-307d. The second terminal of this inductor 307a-307d is coupled to output capacitor 309a-309d and output terminal 303a-303d. The operation of high side switches Q2a-Q2d (304a-304d) and low side switches Q3a-Q3d (306a-306d) controls the current flowing through inductors 307a-307d and thus the voltage across output capacitors 309a-309d.

In some embodiments, the high side switches Q2a-Q2d (304a-304d) and low side switches Q3a-Q3d (306a-306d) may be implemented with four-terminal MOSFETs having their body terminals coupled to ground. Tying the 4^{th} terminal (body) to ground eliminates the parasitic diode associated with a source-body connection being connected to the inductors, thereby maintaining the ability to control the voltage applied to the inductors.

### Asymmetric Control of a Multi Output Three Level Buck Converter

Controlling the multi output three level buck converter illustrated in FIG. 3 is a multi-dimensional challenge. In a single output three level buck converter as illustrated in FIG. 1, there are two parameters that must be controlled: (1) the voltage across the flying capacitor 105, and (2) the output voltage at output terminal 103. In some embodiments, the voltage across the charge pump flying capacitor may be regulated to Vin/2 plus or minus some tolerance. As described with reference to FIG. 2, Phases I and II constitute a complete charge/discharge cycle for output inductor 107 while charging flying capacitor 105, and Phases III and IV constitute a complete charge/discharge cycle for output inductor 107 while discharging flying capacitor 105. Appropriately balancing these two phase pairs allows the flying capacitor voltage to be kept in regulation, while simultaneously keeping the output voltage in regulation. This balancing requires coordinated control between switching devices Q1 and Q4 and switching devices Q2 and Q3. In a simple three level buck converter, the charge pump charge cycle (i.e., Phase I or III) occurs at a duty cycle D that is appropriate for the buck converter. (Duty cycle D represents the ratio of Phases I/II or III/IV and sets the gain of the buck converter.) With a single buck converter coupled to the charge pump, this mode of control works fine. However, with two buck converters coupled to a single charge pump (i.e., the flying rails of the charge pump) they cannot both control the duty cycle D of the charge pump, requiring an adaptation of the control strategy employed in a simple three level buck converter.

One approach to implementing such a control system for a multi output three level buck converter is to adapt the constant on time (“COT”) pulse frequency modulation (“PFM”) controller described in Chapter 2 of Cassidy, Brian Michael, “A Constant ON-Time 3-Level Buck Converter for Low Power Applications” (2015) (“Cassidy”), which is hereby incorporated by reference in its entirety. Cassidy's COT PFM controller is intended for use with a three level buck converter having only a single output stage. To adapt that controller for use with a multi output three level buck converter as illustrated in FIG. 3, an assumption may be made, with corresponding operational constraints placed on the multi output three level buck converter. The assumption being that the first output buck converter stage is always present (i.e., always in operation and loaded) and its energy requirements dominate the multi output converter (i.e., it has a larger output power requirement than the remaining stages). With this assumption, Cassidy's COT PFM controller may be implemented asymmetrically (i.e., to control the input charge pump stage and the first buck converter stage, with the remaining buck converter stages “along for the ride”). As used herein, “asymmetric” means that one buck stage is controlled in coordination with the charge pump stage, and remaining buck stages are slaved to the switching of the charge pump stage, with the attendant consequence that the one coordinated buck stage must be the dominant stage.

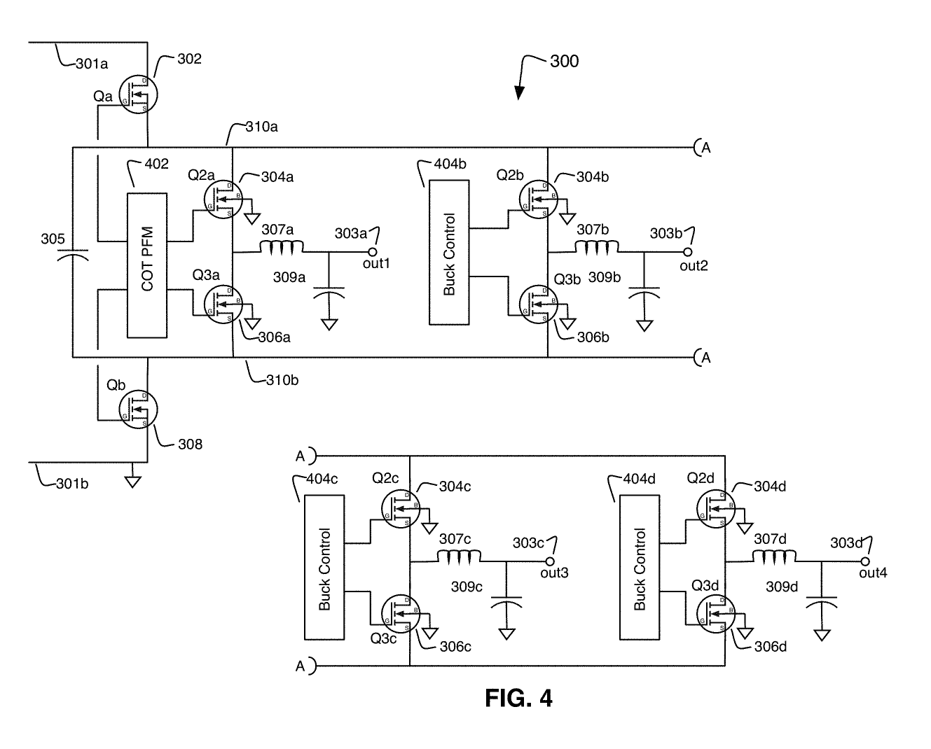

More specifically, with reference to FIG. 4, the input charge pump stage (made up of high and low side switches 302 and 303 and flying capacitor 305) and the first output buck stage (made up of high and low side switches 304a and 306a, output inductor 307a and output capacitor 309a) may be controlled by a COT PFM controller 402, such as that described in Cassidy, or indeed any other control system suitable for a conventional three level buck. The remaining output buck converter stages (made up of high and low side switches 304b-304d and 306b-306d, output inductors 307b-307d, and output capacitors 309b-309d) may have their own buck controllers 404b-404d. Buck controllers 404b-404d may be conventional buck controllers that operate to generate the desired output voltage at the respective outputs 303b-303d while slaved to the operation of the charge pump stage (because the charge pump stage is controlling the state of the flying rails). However, because the main controller is controlling the duty cycle of the charge pump, the slave controllers cannot rely on any specific pulse width of the charge pump controller and so cannot be used to help regulate the voltage of the flying capacitor/flying rails. Furthermore, whereas the main buck converter may be operated in either continuous or discontinuous mode, the slaved converters must be operated in discontinuous mode, and must always require duty cycle D<Dmain (the duty cycle of the main controller).

### Symmetric Control of a Multi Output Three Level Buck Converter

As noted above, an asymmetric control implementation may be based on the assumption that the first buck converter stage's load is always present and dominates the multi-output controller. As a result, operation of a multi output three level buck converter controlled in this fashion may have operating constraints relating to a minimum current from the first stage as well as maximum currents from the remaining stages. In some embodiments, these constraints may be undesirable. Thus, a symmetric controller arrangement, in which each output is treated the same and each output may have any output power draw with good cross regulation. As used herein, “symmetric” means that each buck converter may supply an arbitrary amount of current/power to its load.

Additionally, it may be desirable for such a controller to be able to accommodate a wide range of input voltages. For example, if the multi output three level buck converter is to be powered by a lithium ion cell, it could be expected that the input voltage could range from 4.2V (or more) when the cell is charging, down to 3.2V or less at the end of charge. In such an embodiment, the flying voltage rails 310a and 310b could have a voltage ranging from a high of 2.1V or more to 1.6V or less. For cases in which the converter is powered by multiple cells in series, the input voltages may be an integer multiple of these values. For cases in which another cell chemistry is used, the voltages may vary accordingly. In any event, because the output voltages at the various outputs 303a-303D may be either greater than or less than ½Vin, the control system may preferably be intelligent about the timing of the buck converter switch transitions relative to the state of the charge pump flying rails. For example, at higher input voltages it may be desirable to switch the inductor between ½Vin and 0V, while at lower input voltages it may be desirable to switch the inductor between Vin and ½Vin.

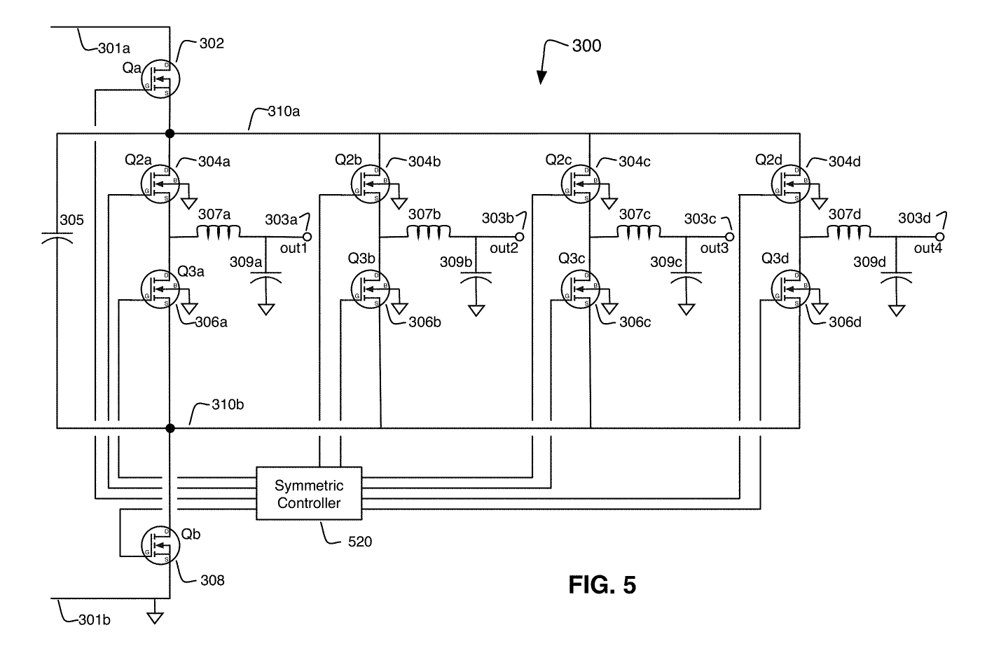

Described below is an integrated symmetric controller that operates all switching devices for a multi output three level buck converter. With reference to FIG. 5, symmetric controller 502 provides gate drive signals for switches Qa and Qb (302, 308), which, with capacitor 305, make up the charge pump stage. Switches Qa and Qb are operated in coordination with the current draw from the buck converters (as described in greater detail below) to regulate the voltage appearing across flying capacitor 305. The voltage across flying capacitor 305 is the voltage between flying rails 310a and 310b and the input voltage to each of the buck converter stages. Symmetric controller 502 also provides the gate drive signals to each of the buck converter stage's high side switches Q2a-Q2d (a/k/a 304a-304d) and low side switches Q3a-Q3d (a/k/a 306a-306d). The described control algorithm has each buck converter operating in a discontinuous current mode (DCM), which is suitable for many low power applications. In alternative embodiments, one buck converter attached to a charge pump may be operated in continuous current mode (CCM), while all other buck converters attached to that charge pump operate in DCM. Additionally, in some embodiments disclosed below, multiple charge pumps may be provided, with one buck converter coupled to each charge pump operating in the CCM and additional buck converters coupled to those charge pumps operating in DCM.

Symmetric controller 502 may be implemented in various ways, including digital, analog, or hybrid digital/analog circuitry. The controller may be constructed from discrete components, integrated circuits, or combinations thereof, and by fixed logic devices, programmable logic devices, or field programmable gate arrays (FPGAs) and the like. In some embodiments, symmetric controller 502 and the switching devices for the charge pump stage and the buck converter stages may be constructed as a single integrated circuit, with only passive components such as the identified inductors and capacitors being external to the IC. In still other embodiments, some or all of the passive components may be integrated with the controller and switching components, although this may not be desirable in all embodiments for efficiency or other reasons. Thus, the foregoing description of symmetric controller 502 focuses on the control loops, algorithms, and logic implemented by the controller, without regard to any particular physical form that such controller may take.

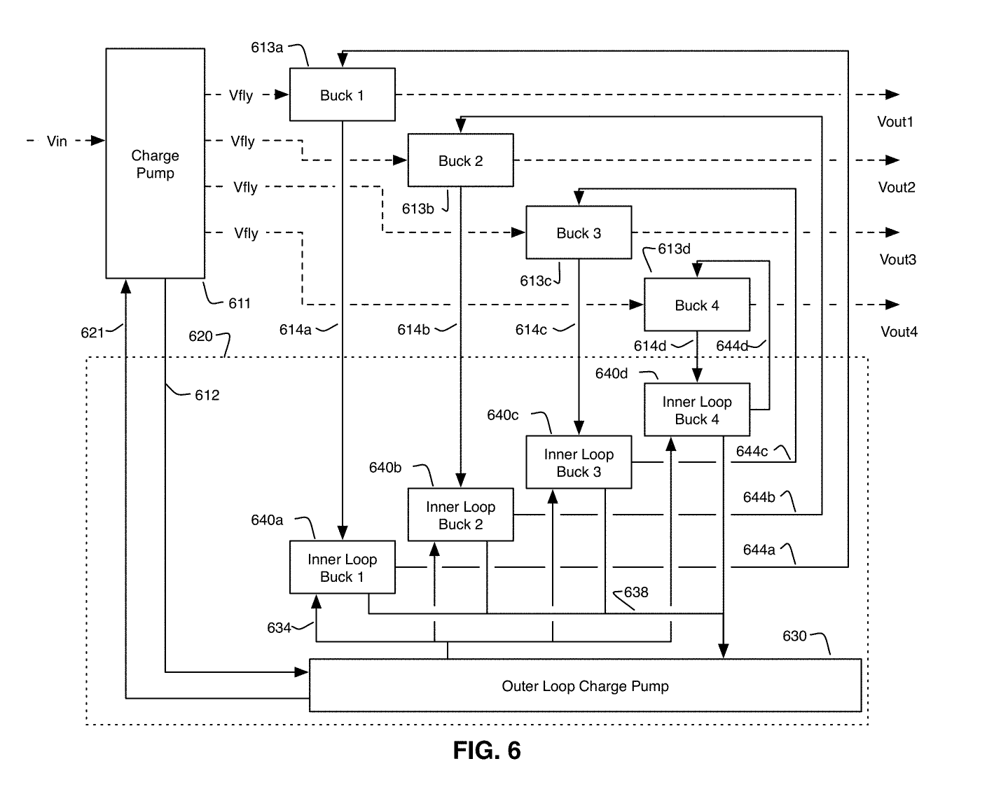

FIG. 6 depicts, in block diagram form, a multi output three level buck converter implementing a symmetric controller 620. Power flow through the converter is depicted using dashed lines, and control signals are depicted using solid lines. The upper portion of FIG. 6 depicts the power components of the multi-output three level buck converter. In the illustrated example, an input voltage Vin is received by charge pump 611. The flying rails Vfly of charge pump 611 are coupled to four buck converters 613a-613d. Buck converters 613a-613d produce output voltages Vout1-Vout4, respectively. It will be appreciated that more or fewer buck converters may be provided in a given implementation. The lower portion of FIG. 6 depicts symmetric controller 620. Symmetric controller 620 includes an outer loop charge pump controller 630 and inner loop buck converter controllers 640a-640d, each corresponding to one of the buck converters 613a-613d.

Symmetric controller 620 implements a separate outer loop controller 630 to regulate the charge pump 611. This allows the four buck converters 613a-613d to operate independently of one another (but not independently of charge pump 611). In other words, the charge pump regulator is not slaved to any one of the buck converters 613a-613d and/or respective controllers 640a-640d. First, outer loop controller 630 can generate a “steer” state signal 634 having two states, “steer” and “˜steer,” discussed in greater detail below. Second, the outer loop controller 630 can generate a system clock 636 that controls the timing (i.e., switching frequency and phase) of the charge pump and the buck converters. Third, the outer loop controller 630 can control the pulse width of the charge pump switching signals.

Steer state signals 634 can be used to instruct the buck converter controllers 640a-640d to either discharge (steer) or charge ˜(steer) the charge pump capacitor. These operations are described in greater detail below. In one embodiment, steer signal 634 may be generated by implementing a hysteretic regulator around the voltage across the flying capacitor (305). A simple hysteretic regulator may be constructed from a comparator and a voltage reference. The comparator generates an output signal based on comparing the feedback voltage (e.g., the voltage across flying capacitor 305) to the reference voltage (e.g., ½Vin). When the flying capacitor voltage is greater than reference voltage, the comparator generates the steer signal, instructing the buck converter controllers to cause the buck converters to discharge the flying capacitor. When the flying capacitor voltage is less than the reference voltage, the comparator generates the steer signal, instructing the buck converters to charge the flying capacitor. Adding hysteresis to this comparator forms a hysteretic controller. In some embodiments, it may be desirable that the transition between the steer and steer states occur at a point in time when none of the buck converter switches are turned on. Otherwise, miss-switching may occur at the steer to steer state transition boundary. Symmetric controller 630 may also implement other controllers or controller types for generating the steer signals 634a-634b for the respective buck controllers 640a-640d.

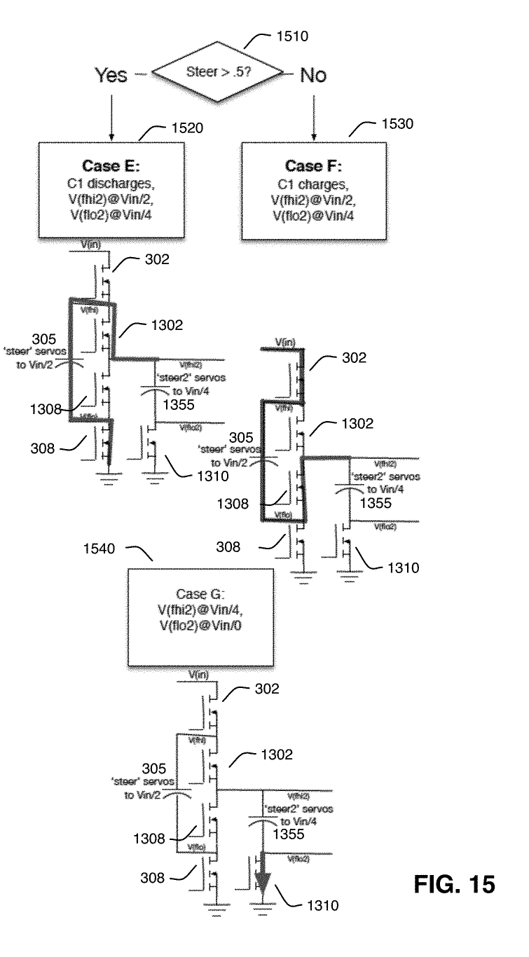

Outer loop charge pump controller 630 can also generate a variable frequency clock 636 for use internally within outer loop charge pump controller 630 and throughout symmetric controller 620 in what is a form of pulse frequency modulation (PFM) that works well with the discontinuous current mode (DCM) operation of the buck converters. Variable frequency clock 636 may be responsive to the maximum error of the buck converters, such that a large maximum error results in a higher switching frequency, while a smaller maximum error results in a lower switching frequency. The variable clock frequency could also be proportional to the load of the most heavily loaded buck converter. Thus, outer loop charge pump controller 630 may be configured to receive an error signal 638 from each of the buck converter controllers 640a-640d. Further, outer loop charge pump controller 630 may include a comparator/selector circuit for identifying which of the buck converter error signals has the greatest maximum error. A variable frequency clock (VCO) 1412; FIG. 14) may be used to control the switching frequency the charge pump and the buck converters, which may be configured to run at the same frequency. Thus, the variable frequency clock signal may be provided to each of the inner loop buck controllers 640a-640d.

Charge pump pulse width, i.e., the on time of the charge pump switching devices 302 and 304, may also be controlled by the outer loop charge pump controller 630. In some embodiments it may be desirable to have this pulse width as a constant, with all control of the charge pump being controlled by the switching frequency, i.e., variable frequency clock 636. For example, a pulse width set at a constant 250 ns would result in a 50% duty cycle at maximum switching frequency of 2 MHz, although other values may be selected. Alternatively, the charge pump pulse width may be a controlled variable, rather than a constant. Such dynamic control of the charge pump pulse width could be used to improve the efficiency of the converter and/or reduce the output ripple. Alternatively, the charge pump pulse width may be controlled to be equal to the required duty cycle of one of the converters, thus allowing one of the converters to operate in continuous current mode. It should be noted, however, that the predictive control for States A and D, described below, relies on the inner regulators knowing this pulse width.

Outer loop charge pump controller also generates an output signal 621 that is the gate drive signals for the charge pump FETs 302 and 304. These gate control signals may be produced by a gate drive controller implemented within outer loop charge pump controller 630 and responsive to the variable frequency clock signal and pulse width signals discussed above.

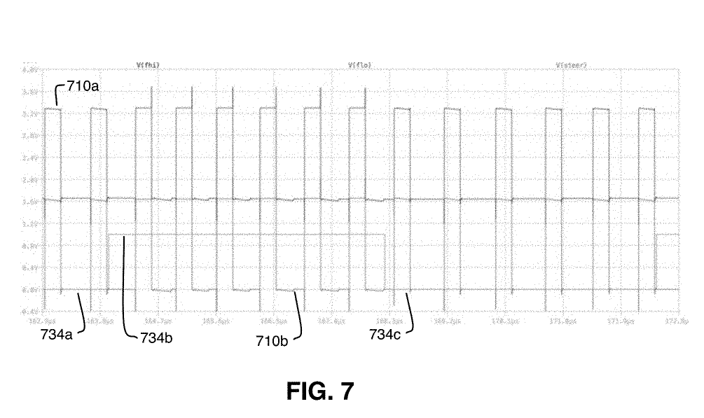

Exemplary waveforms for the charge pump stage of such an embodiment are illustrated in FIG. 7. Waveform 710a depicts the voltage of high flying rail 310a, and waveform 710b depicts the voltage of low flying rail 310b. The difference between these two voltages is the voltage across the flying capacitor 305. The steering signal is depicted in three zones: 734a, having a low voltage corresponding to the “˜steer” state in which the buck converters are charging the flying capacitor; 734b, having a high voltage corresponding to the “steer” state in which the buck converters are discharging the flying capacitor; and 734c, having a low voltage again corresponding to the “˜steer” state. As can be seen, the high flying rail 310a is switching between Vin and ½Vin, and the low flying rail 310b is switching between ½Vin and 0V. The steering signal 734 is toggling between its two states at a rate determined by the hysteresis of its regulator, and the output power of the buck converters. At low output powers the toggling frequency will be low, while at high output powers the toggling frequency will be higher. The toggling frequency will be inversely proportional to the hysteresis of the regulator, i.e., the larger the hysteresis, the lower the toggling frequency, for a given output power.

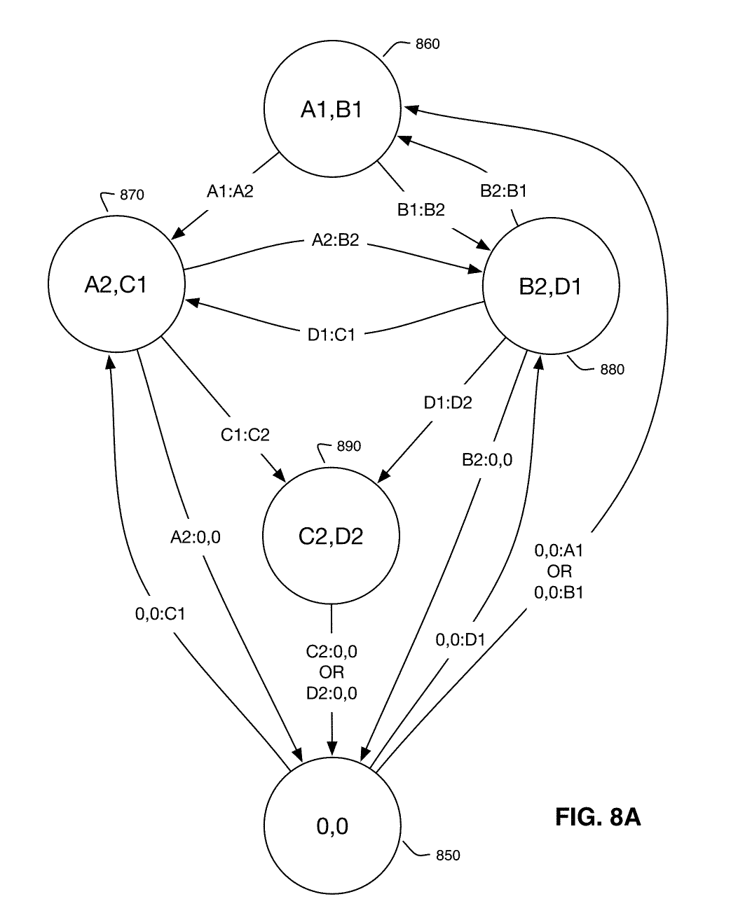

As illustrated in FIG. 6, each buck converter 613a-613d has a corresponding inner loop buck controller 640a-640d. A state diagram of an exemplary inner loop buck controller is diagrammed in FIG. 8A. FIG. 8B illustrates the switching states of a buck converter implementing such a controller, along with partial schematics illustrating current flow for inductor charge (upper) and discharge (lower) for each case. Each inner loop buck controller may implement an identical controller. Alternatively, in some embodiments, if it is known that the target voltage/setpoint of the buck converter (i.e., Vset) is always greater than the flying rail/flying capacitor voltage (e.g., ½Vin), then the half of the inner loop buck controller corresponding to the case in which the target voltage/setpoint of the buck converter is less than the flying rail/flying capacitor voltage may be omitted. Conversely, if the target voltage/setpoint of the buck converter (i.e., Vset) will always be less than the flying rail/flying capacitor voltage (e.g., ½Vin), then the half of the inner loop buck controller corresponding to the case in which the target voltage /setpoint of the buck converter is greater than the flying rail/flying capacitor voltage may likewise be omitted. The following description focuses on the general case in which the target voltage/setpoint of the buck converter (i.e., Vset) may be greater than or less than the flying rail/flying capacitor voltage (e.g., ½ Vin).

Each inner loop buck controller 640a-640d receives from its respective buck converter an input 614a-614d that is a feedback signal indicating output voltage of the buck regulator. In other embodiments, this feedback signal could include a load on the buck converter or an output current of the buck converter. In any case, the controller can use this feedback signal to derive the required switching signals to keep the buck converter's output in regulation. For example, each inner loop buck controller 640a-640d can implement a voltage control loop. This voltage control loop can derive from its respective feedback signal 614a-614d and its setpoint an error signal “err” 638. In some switching states, this error signal 638 may be used as a peak current target (like current mode control) for the current through inductor 307. However, for other switching states, the time at which the rising current ramp is terminated is not under control of the inner loop buck regulators 640a-640d, but rather under the control of outer loop charge pump controller 630). In those switching states, to control the buck converters 613a-613d, the inner loop buck controllers 640a-640d must use the known rate at which the current ramps (which is determined by the input and output voltages and the inductance values of the buck converters as described below) to calculate the time at which the current ramp should begin. It should be noted that the inner loop controllers also are looking at inductor current. For the ‘current mode control’ control states (B and C, discussed below), the inductor current is compared to the error and used to terminate the inductor charging state (i.e., States B1 and C1). For all four control states the inductor current value is used to terminate the inductor discharging state (A2-D2). Negative values of inductor current should be prevented, as negative inductor current would discharge the output capacitor.

Each inner loop buck controller 640a-640d also receives three inputs (collectively labeled 634) from the outer loop charge pump controller 630. These inputs are: the steer signal discussed above, the clock signal discussed above, and a variable associated with the pulse width (the time high side charge pump switch Qa 302 is on), which the inner loop buck controllers 640a-640d use to know when the charge pump will change stage for use with the predictive control algorithm. Each inner loop buck controller has another output in addition to error signal 638 discussed above, namely the switching gate drive signals 644a-644d, which are generated as described below and provided to the respective buck converters 613a-613d.

As noted above, FIG. 8A illustrates a state diagram of an inner loop buck converter controller. The inner loop buck converter controller has five states. State 0,0 (850) corresponds to the state in which both buck converter switches (i.e., switches Q1 (304) and Q2 (306) in FIG. 8B) are off. In state 0,0 (850) charge pump switches Qa (302) and Qb (308) may be in any state as determined by outer loop charge pump controller 630. State A1,B1 (860) corresponds to the first state of Cases A and B (described further below with reference to FIG. 8B) in which charge pump switch Qa (302) and buck converter switch Q1 (304) are on. State A2,C1 (870) corresponds to the second state of Case A and the first state of Case C (described further below with reference to FIG. 8B) in which charge pump switch Qb (308) and buck converter switch Q1 (304) are on. State B2,D1 (880) corresponds to the second state of Case B and the first state of Case D (described further below with reference to FIG. 8B) in which charge pump switch Qa (302) and buck converter switch Q2 (306) are on. State C2,D2 (890) corresponds to the second state of Cases C and D (described further below with reference to FIG. 8B) in which charge pump switch Qb (308) and buck converter switch Q2 (306) are on. Operation of the buck converter controller and transitions between the states are as described below with reference to FIGS. 8A and 8B.

### Case A

0,0:A1-- err>vdeadband & Vout>Vin/2 & Steer=True & Pred_Timer=↑

In Case A (described further below), the buck converter controller operates in discontinuous current mode cycling among three states. The first state is State 0,0 (860), in which the buck converter has zero current. The second state is State A1 (860) in which buck inductor 307 is charged from the high input voltage rail Vin using buck converter switch Q1 (304) during the time period that charge pump high side switch Qa (302) is closed. The third state is A2 (870) in which buck inductor 307 and flying capacitor 305 are discharged using buck converter switch Q1 (304) during the time period that charge pump low side switch Qb (308) is closed. Starting from State 0,0 (850), the buck controller transitions to state A1 (via transition 0,0:A1) when the following conditions are met:
the buck controller's error signal “err” is greater than a deadband “Vdeadband” AND
the output setpoint voltage of the buck converter is greater than one-half the input voltage (i.e., Vout>½Vin) AND
the “steer” signal generated by outer loop charge pump controller 630 is high (indicating that the buck converter should be operated to discharge flying capacitor 305) AND
buck controller's predictive timer has transitioned high, indicating that it is time to begin charging output inductor 307.
   Each of these four conditions is explained further below.

The first condition that must be satisfied for the 0,0:A1 transition to occur is that the buck controller's error signal be greater than a deadband. The buck controller may implement any of a variety of output controllers that compare the buck converters desired or setpoint output voltage (Vset) to its actual voltage (Vout) and implements an selected control law to control operation of the switches to keep the output voltage at the setpoint. In some embodiments, the control law may be a proportional-integral (i.e., PI control loop), although other control laws may also be used. Because the overall switching frequency of the system is proportional to the most heavily loaded converter (via the outer loop controller), A mechanism is required to reduce the switching frequency of the less heavily loaded converters. This is the function of the deadband. By requiring that a converter have some error greater than this deadband value, the less heavily loaded converters will switch at some sub-multiple of the main clock, with each switching event transferring a larger “packet” of energy than if it were switching at the main clock frequency. This reduces switching loss, which improves overall efficiency.

The second condition that must be satisfied for the 0,0:A1 transition to occur is that the output setpoint voltage of the buck converter be greater than one half the input voltage. If the output setpoint voltage is less than one half the input voltage, the buck converter controller will operate in one of Cases C or D, as described below.

The third condition that must be satisfied for the 0,0:A1 transition to occur is that the “steer” signal generated by outer loop charge pump controller be high, indicating that the buck converters should be operated to discharge flying capacitor 305. If the “steer” signal is low, indicating that the buck converters should operate to charge flying capacitor 305, the buck converter controller will operate in one of cases B or C, as described below.

The fourth condition that must be satisfied for the 0,0:A1 transition to occur is that the buck controller's predictive timer have transitioned high, indicating that it is time to begin charging output inductor 307. In Case A, the buck converter controller does not have full control of the switches that control the current through output inductor 307 because the buck converter controller does not have control of the transitions of charge pump switches Qa (302) and Qb (308), which are controlled by outer loop charge pump controller 630 as described above. However, the buck converter controller can know the time at which the charge pump will transition from the high switch Qa (302) to low switch Qb (308), which information is received from outer loop charge pump controller 630 as described above. As a result, the buck converter controller can calculate (i.e., predict) the time at which buck converter high switch Q1 (304) should be turned on to deliver sufficient energy to output inductor 307 by the time that the charge pump switch transition takes place. This prediction signal is then the final condition that must be satisfied for the 0,0:A1 transition.

As described above, in State A1 (860), the buck converter controller turns on high buck converter switch Q1 (304). This begins charging output inductor 307 from the high input voltage rail through charge pump switch Qa (302), which was already turned on by outer loop charge pump controller 630.

A1:A2-- Qb=↑

Once in State A1 (860), the buck converter controller will transition to State A2 (870) when the charge pump transitions state. (As described above, the charge pump transitions are controlled by outer loop charge pump controller 630.) More specifically, when the charge pump controller detects that charge pump switch Qb (308) has turned on, it makes the A1:A2 transition. As described above, in State A2 (870), the buck converter turns on low buck converter switch Q2 (306). This begins discharging output inductor through flying capacitor 305. This also has the effect of discharging flying capacitor 305 (as directed by the steer signal).

### A2:0,0-- I(L)<0

Once in State A2 (870), the buck converter controller will transition to State 0,0 (850) when output inductor 307 has completely discharged, i.e., when the inductor current becomes zero. To transition from State A2 to State 0,0 Q2 (306) must be turned off, otherwise the inductor current will continue decreasing (and go negative). To do so, one can either sense the inductor current or use a predictive algorithm similar to that already described. This is the “discontinuous” current of the DCM mode of operation. Assuming that the first three conditions discussed above remain true, the buck converter controller will transition again to the A1 state when next indicated by the predictive controller. Otherwise:
if the buck controller's error signal becomes less than the deadband, the converter will remain idle; OR
if the buck controller output setpoint changes to less than ½Vin, then the buck controller will transition to Case C or D operation as described below; OR
if the steer signal transitions low, then the buck controller will transition to Case B or D operation as described below.

### A2:B2-- Qa=↑*

Ordinarily in State A2, the current in the inductor will decay to 0 and the controller will transition to State 0,0 before Qa is turned on again by the outer loop. However, in some cases (e.g., when Vout is very close to ½Vin) it may be possible for the inductor to discharge sufficiently slowly that it does not reach zero current before the charge pump switches transition from Qb (308) on to Qa (302) on. In those cases, to prevent uncontrolled current, the controller will transition from State A2 to State B2.

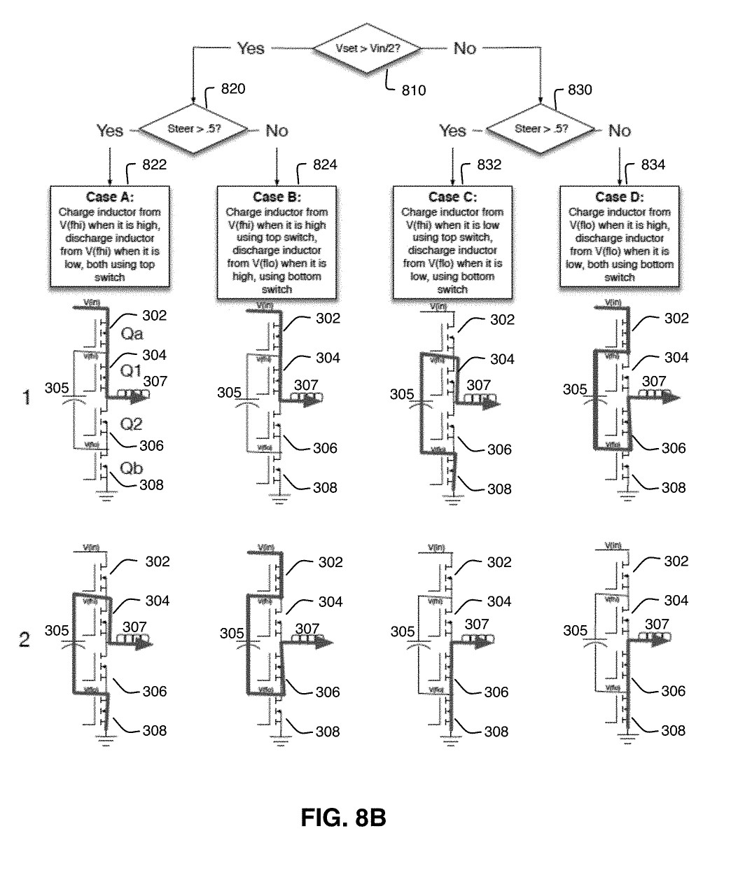

Case A, corresponding to block 822, arises when the target voltage/setpoint (Vset) of the buck converter is greater than the flying rail/flying capacitor voltage (e.g., ½ Vin) and the outer loop charge pump controller is providing a steering signal indicating that flying capacitor 305 should be discharged by buck inductor 307. The buck controller thus alternates between: (1) charging buck inductor 307 from the high input voltage rail Vin (using switch 304 during the time period that charge pump high side switch 302 is closed and (2) discharging buck inductor 307 and flying capacitor 305 (using switch 304 during the time period that charge pump low side switch 308 is closed). For case A, the inductor current cannot be controlled directly, so a predictive control algorithm may be implemented. The transition from inductor charge (ramp up current) to discharge (ramp down current) occurs when charge pump FETs 302 and 308 change state, which is controlled by the outer loop charge pump controller discussed above, and therefore is not under control of the buck converter control loops. Thus, for Case A, the proper switching time may be calculated using knowledge of the input and output voltages and inductor value. This calculated on time may then be used to determine the delay between the charge pump switch transition and the turn on time of the buck converter charging switch, i.e., a predicted turn on time. The reversal of state from charging inductor 307 to discharging inductor 307 will then be determined by the transition of the charge pump switches 302 and 308, as described above and illustrated in the waveforms of FIG. 9 discussed below.

Waveforms corresponding to Case A are illustrated in FIG. 9. The voltage of the high flying rail 710a, low flying rail 710b, and steering signal 734a are as described above with respect to FIG. 7. The steering signal waveform is constant at 1.0V, because for Case A the steering signal always indicates that the regulator is to discharge flying capacitor 305. Waveform 902 illustrates the voltage appearing at the junction of buck converter high side switch 304 and buck converter low side switch 306, which is determined by the switching states described above with respect to FIG. 8. Waveform 904 illustrates the current flowing through buck inductor 307. It can be seen that the inductor is operated in discontinuous mode using predictive switching control as described above.

For instance, at time T=291.84 μs: switch Qa (302) is turned on, pulling the high flying rail 310a voltage V(fhi) 710a up to approximately Vin and the low flying rail 310b voltage V(flo) 710b to approximately ½Vin. Then, at time T=292 μs switch Q1 (304) is turned on by the inner loop controller, using its predictive current algorithm, initiating the ramping of current in inductor 307, at rate (Vin-Vout)/L. At time T=292.08 μs: switch Qa (302) is turned off, and switch Qb (308) is turned on, by outer loop charge pump controller 630. Switch Q1 (304) remains on. The voltage V(fhi) of high flying rail 310a transitions from approximately Vin to approximately ½Vin. Now, the voltage across inductor 307 is (½Vin-Vout)/L. Because Vout>½Vin, the inductor voltage is negative, so the current in inductor 307 ramps down until it hits 0 at T=292.2 μs.

### Case B

0,0:B1-- err>vdeadband & Vout>Vin/2 & Steer=False & Qa=↑

In Case B (described further below), the buck converter controller operates in discontinuous current mode cycling among three states. The first state is 0,0 State 850, in which the buck converter has zero current. The second state is State B1 (860) (having the same switch positions as State A1, discussed above) in which buck inductor 307 is charged from the high input voltage rail Vin using buck converter switch Q1 304 during the time period that charge pump high side switch Qa 302 is closed. The third state is B2 (880) in which buck inductor 307 is discharged and flying capacitor 305 is charged using charge pump switch Qa (302) and buck converter switch Q2 (306). Starting from State 0,0 (850), the buck controller transitions to State B1 (870) (via transition 0,0:B1) when the following conditions are met:
the buck controller's error signal “err” is greater than a deadband “Vdeadband” AND
the output setpoint voltage of the buck converter is greater than one-half the input voltage (i.e., Vout>½Vin) AND
the “steer” signal generated by outer loop charge pump controller 630 is low (indicating that the buck converter should be operated to charge flying capacitor 305) AND
charge pump high side switch Qa 302 has turned on.
   The first two conditions were explained above with reference to Case A. The remaining two conditions are explained further below.

The third condition that must be satisfied for the 0,0:B1 transition to occur is that the “steer” signal generated by outer loop charge pump controller be low, indicating that the buck converters should be operated to charge flying capacitor 305. If the “steer” signal is high, indicating that the buck converters should operate to charge flying capacitor 305, the buck converter controller will operate in one of Cases A or D, as described elsewhere herein.

The fourth condition that must be satisfied for the 0,0:B1 transition to occur is that the charge pump's high side switch Qa (302) have turned on. This means that the controller can begin charging the output inductor.

As described above, in State B1 (860), the buck converter controller turns on high buck converter switch Q1 (304). This begins charging output inductor 307 from the high input voltage rail through charge pump switch Qa (302), which was turned on by outer loop charge pump controller 630, triggering the transition to state B1 (870).

### B1:B2-- I(L)>err

Unlike Case A (i.e., States 0,0; A1; A2), described above, in Case B (i.e., States 0,0; B1; B2) the buck converter controller has complete control of the inductor current. Having begun charging output inductor 307 on entry into State B1 (860), the controller can transition to State B2 (880) when the inductor current reaches its target value. For example, if the controller is implementing peak current mode control using a PI control loop like that described above, it would initiate the B1:B2 transition when the inductor current reached the peak current value corresponding to the error signal “err.” This transition results in the opening of buck converter switch Q1 (304) and the closing of buck converter switch Q2 (306), which begins the discharge of output inductor 307 (and the charging of flying capacitor 305).

### B2:0,0-- I(L)<0

Once in State B2 (880), the buck converter controller will transition to State 0,0 (850) when output inductor 307 has completely discharged, i.e., when the inductor current becomes zero. This is the “discontinuous” current of the DCM mode of operation. Assuming that the first three conditions discussed above remain true, the buck converter controller will transition again to the B1 state when charge pump switch Qa (302) next closes. Otherwise:

if the buck controller's error signal becomes less than the deadband, the converter will remain idle; OR
if the buck controller output setpoint changes to less than ½Vin, then the buck controller will transition to Case C or D operation as described below; OR if the steer signal transitions high, then the buck controller will transition to Case A or C operation as described below.

Case B, corresponding to block 824, arises when the target voltage/setpoint (Vset) of the buck converter is greater than the flying rail/flying capacitor voltage (e.g., ½ Vin) and the outer loop charge pump controller is providing a steering signal indicating that the flying capacitor 305 should be charged by buck inductor 307. The buck controller thus alternates between: (1) charging the buck inductor from the high input voltage rail Vin (using switch 304) and (2) charging the flying capacitor 305 by discharging buck inductor 307 (using switches 306 and high side charge pump switch 302). In case B, the current through buck inductor 307 can be controlled directly, using peak current mode control, for example. In such an embodiment, the switching transition from buck converter high side switch 304 to buck converter low side switch 306 may be made when the inductor current reaches its target.

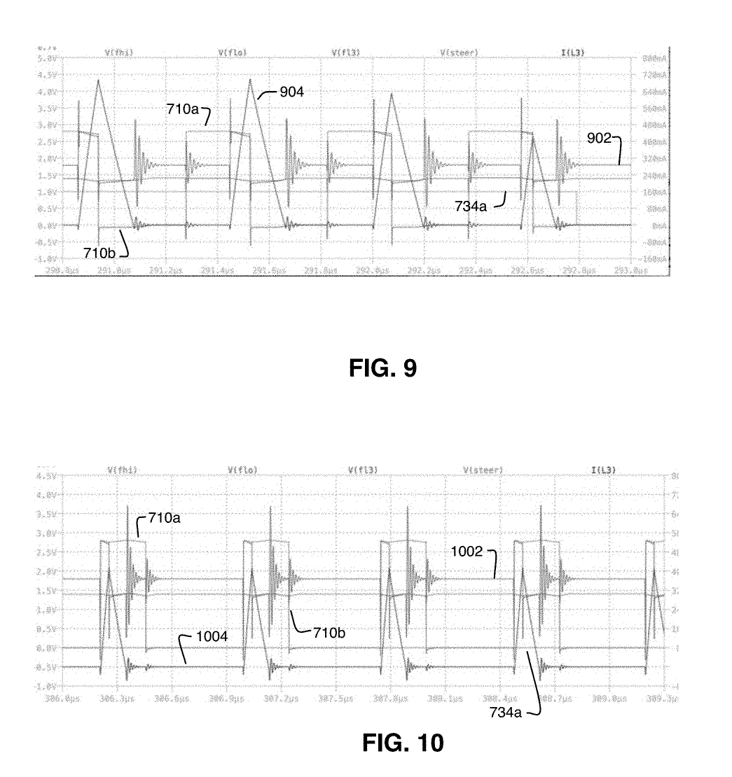

Waveforms corresponding to Case B are illustrated in FIG. 10. The voltage of the high flying rail 710a, low flying rail 710b, and steering signal 734a are as described above with respect to FIGS. 7 and 8. The steering signal waveform is constant at 0.0V, because for Case B the steering signal always indicates that the regulator is to charge flying capacitor 305. Waveform 1002 illustrates the voltage appearing at the junction of buck converter high side switch 304 and buck converter low side switch 306, which is determined by the switching states described above with respect to FIG. 8. Waveform 1004 illustrates the current flowing through buck inductor 307. It can be seen that the inductor is operated in discontinuous mode, using peak mode current control as described above.

For instance, at time T=307.75 μs, both switches Qa (302) and Q1 (304) are turned on (the former by outer charge pump control loop 630, the latter by the inner loop 640a). This pulls the voltage V(fhi) 710a of flying rail 310a up to approximately Vin and the voltage V(flo) 710b of flying rail 310b to approximately ½Vin. This also initiates the ramping of current in inductor 307, at a rate (Vin-Vout)/L. Then, at time T=307.8 μs, Q1 (304) is turned off, and Q2 (306) is turned on, both by inner loop buck controller 640a, in response to the current in inductor 307 reaching its target. At this point, the voltage across inductor 307 is (½Vin-Vout)/L. Because Vout is greater than ½Vin, the voltage across the inductor is negative. Thus, the current in the inductor ramps down until it reaches 0 at T=307.9 μs.

### Case C

0,0:C1-- err>vdeadband & Vout<Vin/2 & Steer=True & Qb=↑

In Case C (described further below), the buck converter controller operates in discontinuous current mode cycling among three states. The first state is State 0,0 850, in which the buck converter has zero current. The second state is State C1 (870) in which buck inductor 307 is charged from the flying rail/charge pump capacitor 305 using buck converter switch Q1 (304) during the time period that charge pump low side switch Qb (308) is closed. The condition of the buck converter switches in State C1 (870) is the same as in State A2 (870) discussed above. The third state is C2 (890) in which buck inductor 307 is discharged using buck converter switch Q2 (306) during the time period that charge pump low side switch Qb (308) is closed. Starting from State 0,0 (850), the buck controller transitions to state C1 (via transition 0,0:C1) when the following conditions are met:
the buck controller's error signal “err” is greater than a deadband “Vdeadband” AND
the output setpoint voltage of the buck converter is less than one-half the input voltage (i.e., Vout<½Vin) AND
the “steer” signal generated by outer loop charge pump controller 630 is high (indicating that the buck converter should be operated to discharge flying capacitor 305) AND
charge pump low side switch Qb 308 has turned on.
   The first and third conditions were explained above with reference to Case A. The remaining two conditions are explained further below.

The second condition that must be satisfied for the 0,0:C1 transition to occur is that the output setpoint voltage of the buck converter be less than one half the input voltage. If the output setpoint voltage is greater than one half the input voltage, the buck converter controller will operate in one of Cases A or B, as described above.

The fourth condition that must be satisfied for the 0,0:C1 transition to occur is that the charge pump's low side switch Qb (308) have turned on. This means that the controller can begin charging the output inductor.

As described above, in State C1 (870), the buck converter controller turns on high buck converter switch Q1 (304). This begins charging output inductor 307 from flying capacitor 305 through charge pump switch Qb (308), which was already turned on by outer loop charge pump controller 630.

### C1:C2-- I(L)>err

Unlike Case A (i.e., States 0,0; A1; A2) and like Case B (i.e., States 0,0; B1; B2) described above, in Case C (i.e., States 0,0; C1; C2) the buck converter controller has complete control of the inductor current. Having begun charging output inductor 307 on entry into State C1 (870), the controller can transition to State C2 (890) when the inductor current reaches its target value. For example, if the controller is implementing peak current mode control using a PI control loop like that described above, it would initiate the C1:C2 transition when the inductor current reached the peak current value corresponding to the error signal “err.” This transition results in the opening of buck converter switch Q1 (304) and the closing of buck converter switch Q2 (306), which begins the discharge of output inductor 307.

### C2:0,0-- I(L)<0

Once in State C2 (890), the buck converter controller will transition to State 0,0 (850) when output inductor 307 has completely discharged, i.e., when the inductor current becomes zero. This is the “discontinuous” current of the DCM mode of operation. Assuming that the first three conditions discussed above remain true, the buck converter controller will transition again to the C1 state when charge pump switch Qb (308) next closes. Otherwise:
if the buck controller's error signal becomes less than the deadband, the converter will remain idle; OR
if the buck controller output setpoint changes to greater than ½Vin, then the buck controller will transition to Case A or B operation as described above; OR
if the steer signal transitions low, then the buck controller will transition to Case B operation as described above or Case D operation as described below.

Case C, corresponding to block 832, arises when the target voltage/setpoint (Vset) of the buck converter is less than the flying rail/flying capacitor voltage (e.g., ½ Vin) and the outer loop charge pump controller is providing a steering signal indicating that the flying capacitor 305 should be discharged by the buck inductor 307. The buck controller thus alternates between: (1) charging buck inductor 307 by discharging flying capacitor 305 (using switches 304 and 308) and (2) discharging the buck inductor (using switches 306 and 308). In Case C, like Case B, the current through buck inductor 307 can be controlled directly, using peak current mode control, for example. In such an embodiment, the switching transition from buck converter high side switch 304 to buck converter low side switch 306 may be made when the inductor current reaches its target.

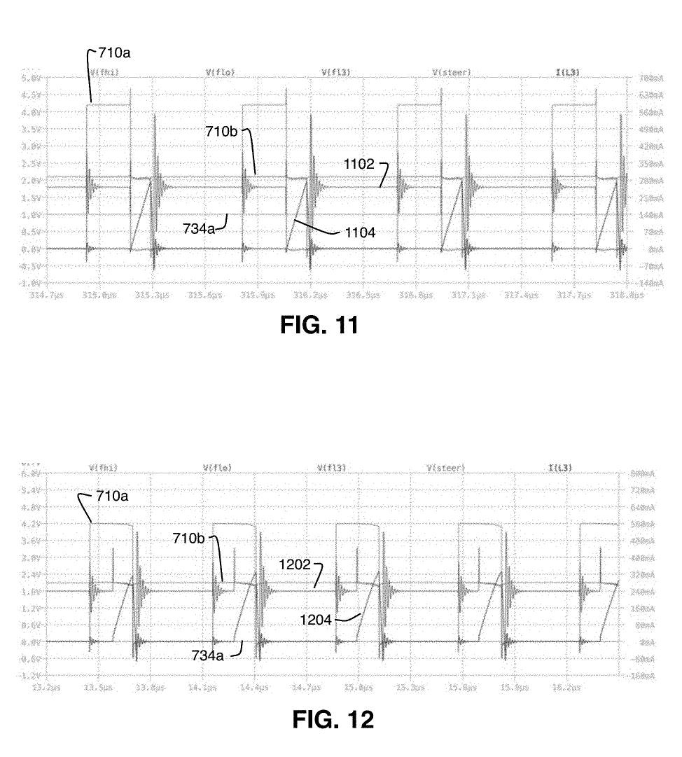

Waveforms corresponding to Case C are illustrated in FIG. 11. The voltage of the high flying rail 710a, low flying rail 710b, and steering signal 734a are as described above with respect to FIGS. 7, 8, and 10. The steering signal waveform is constant at 1.0V, because for Case B the steering signal always indicates that the regulator is to charge flying capacitor 305. Waveform 1102 illustrates the voltage appearing at the junction of buck converter high side switch 304 and buck converter low side switch 306, which is determined by the switching states described above with respect to FIG. 8. Waveform 1104 illustrates the current flowing through buck inductor 307. It can be seen that the inductor is operated in discontinuous mode, using peak mode current control as described above.

For instance, at time T=315.15 μs, both switches Q1 (304) and Qb (308) are turned on (the latter by outer charge pump control loop 630, the former by the inner loop 640a). This pulls the voltage V(fhi) 710a of flying rail 310a down to approximately ½Vin and the voltage V(flo) 710b of flying rail 310b to approximately 0. This also initiates the ramping of current in inductor 307, at a rate (½Vin-Vout)/L. Then, just before time T=315.3 μs, Q1 (304) is turned off, and Q2 (306) is turned on, both by inner loop buck controller 640a, in response to the current in inductor 307 reaching its target. Switch Qb (308) remains on. At this point, the voltage across inductor 307 is (0−Vout)/L. Because the voltage across the inductor is negative, the current in the inductor ramps down until it reaches 0 at T=315.3 μs.

### Case D

0,0:D1-- err>vdeadband & Vout<(Vin/2) & Steer=False & Pred_Timer=↑

In Case D (described further below), the buck converter controller operates in discontinuous current mode cycling among three states. The first state is State 0,0 (850), in which the buck converter has zero current. The second state is State D1 (880) in which buck inductor 307 is charged from the flying rail/charge pump capacitor 305 using buck converter switch Q2 (306) during the time period that charge pump high side switch Qa (302) is closed, which also charges flying capacitor 305. The third state is D2 (890) in which buck inductor 307 is discharged using buck converter switch Q2 (306) during the time period that charge pump low side switch Qb (308) is closed. Starting from State 0,0 (850), the buck controller transitions to state D1 (via transition 0,0:D1) when the following conditions are met:
the buck controller's error signal “err” is greater than a deadband “Vdeadband” AND
the output setpoint voltage of the buck converter is less than one-half the input voltage (i.e., Vout<½Vin) AND
the “steer” signal generated by outer loop charge pump controller 630 is low (indicating that the buck converter should be operated to charge flying capacitor 305) AND
buck controller's predictive timer has transitioned high, indicating that it is time to begin charging output inductor 307.
   The first three conditions have been explained above. The fourth condition is explained below.

The fourth condition that must be satisfied for the 0,0:D1 transition to occur is that the buck controller's predictive timer has transitioned high, indicating that it is time to begin charging output inductor 307. In Case D (like Case A, discussed above) the buck converter controller does not have full control of the switches that control the current through output inductor 307 because the buck converter controller does not have control of the transitions of charge pump switches Qa (302) and Qb (308), which are controlled by outer loop charge pump controller 630 as described above. However, the buck converter controller can know the time at which the charge pump will transition from the high switch Qa (302) to low switch Qb (308), which information is received from outer loop charge pump controller 630 as described above. As a result, the buck converter controller can calculate (i.e., predict) the time at which buck converter high switch Q2 (306) should be turned on to deliver sufficient energy to output inductor 307 by the time that the charge pump switch transition takes place. This prediction signal is then the final condition that must be satisfied for the 0,0:D1 transition.

As described above, in State D1 (880), the buck converter controller turns on low buck converter switch Q2 (306). This begins charging output inductor 307 from the flying rail/charge pump capacitor 305 through charge pump switch Qa (302), which was already turned on by outer loop charge pump controller 630.

### D1:D2-- Qb=↑& Vout<Vin/2 & I(L)≥error

Once in State D1 (880), the buck converter controller will transition to State D2 (890) when the charge pump transitions state, provided that Vout remains less than ½ Vin and the inductor current is greater than the value indicated by the “err” signal. (As described above, the charge pump transitions are controlled by outer loop charge pump controller 630.) More specifically, when the charge pump controller switches charge pump switch Qb (308) on, it makes the D1:D2 transition if Vout remains less than ½Vin and the inductor current is greater than or equal to the value specified by the current control loop. The condition that Vout remain less than ½Vin and that the inductor current have reached a minimum value indicated by the control loop error signal are to account for the case in which the output voltage is very close to the flying capacitor voltage. In such case, the inductor will charge very slowly. In some cases, the inductor might not have time to charge sufficiently to keep the buck converter output in regulation. It is desired that the control system prioritizes output regulation of the buck over voltage regulation of the flying capacitor. Therefore, if sufficient energy has not been transferred to the inductor by the time the charge pump switches transition from Qa (302) on to Qb (308), the controller will transition from D1 to state C1 as described in further detail below. Otherwise, as described above, in State D2 (890), the buck converter turns on low buck converter switch Q2 (306). This begins discharging output inductor through flying capacitor 305.

### D2:0,0-- I(L)<0

Once in State D2 (890), the buck converter controller will transition to State 0,0 (850) when output inductor 307 has completely discharged, i.e., when the inductor current becomes zero. This is the “discontinuous” current of the DCM mode of operation. Assuming that the first three conditions discussed above remain true, the buck converter controller will transition again to the D1 state when charge pump switch Qa (302) next closes. Otherwise:
if the buck controller's error signal becomes less than the deadband, the converter will remain idle; OR
if the buck controller output setpoint changes to greater than ½Vin, then the buck controller will transition to Case A or B operation as described above; OR
if the steer signal transitions high, then the buck controller will transition to Case A or B operation as described above.

### D1:C1-- Qb=↑& Vout<Vin/2 & I(L)<err

As discussed briefly above, while operating in Case D, if the inductor does not sufficiently charge during state D1, the controller will transition to State C1 when the charge pump switches from Qa (302) on to Qb (308) on. This will allow output inductor 307 to continue charging, now from flying capacitor 305, to ensure sufficient energy is transferred to the output of the buck converter. As noted above, this prioritizes buck converter output voltage regulation (which is typically more important) over flying capacitor voltage regulation (which is typically less important). This additional state transition may be omitted if, in some application, flying capacitor voltage regulation were more important than buck converter output voltage regulation.

Once the buck converter controller has transitioned from State D1 to State C1, it will either transition to State C2, and then to State 0,0 as described above (assuming the inductor is eventually fully charged and discharged) or it will transition back to state D1 as described below

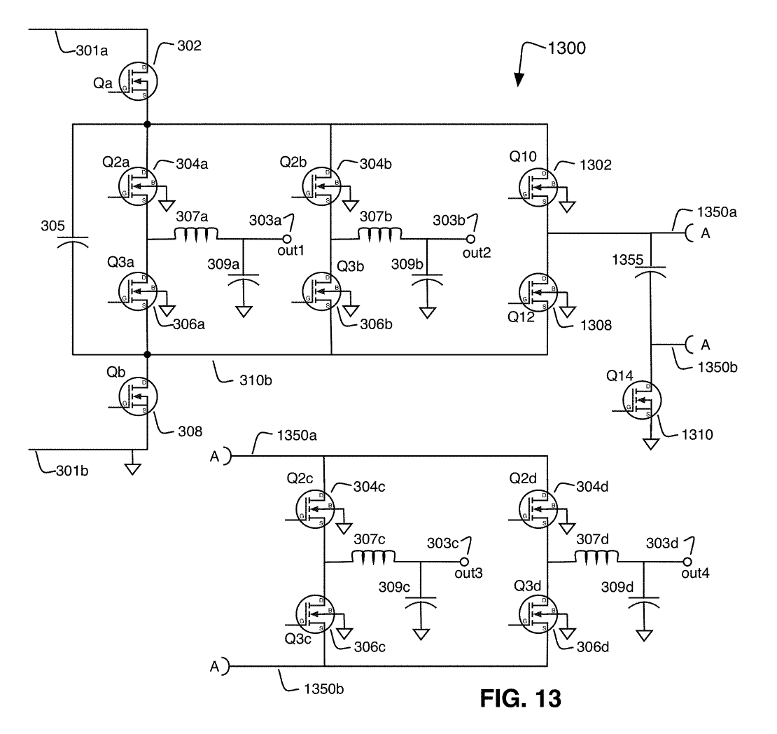

Case D, corresponding to block 834, arises when the target voltage/setpoint (Vset) of the buck converter is less than the flying rail/flying capacitor voltage (e.g., ½ Vin) and the outer loop charge pump controller is providing a steering signal indicating that the flying capacitor 305 should be charged by the buck inductor 307. The buck controller thus alternates between: (1) charging the buck inductor 307 and flying capacitor 305 from the high input voltage rail Vin (using switch 306 while charge pump high side switch 302 is closed) and (2) discharging the buck inductor 307 (using switches 306 and 308). In case D, like Case A, the inductor current cannot be controlled directly, and thus predictive control may be used. For Case D, as with Case A, the turn on time of the switch may be predicted using knowledge of the input and output voltages and inductor value. This predicted on time may then be used to determine the delay between the charge pump switch transition (Qa, 302) and the turn-on time of the buck converter charging switch (Q2, 304). The change of state from charging inductor 307 to discharging inductor 307 will be determined by the transition of the charge pump switches 302 and 308, as illustrated in the waveforms of FIG. 12.

Waveforms corresponding to Case D are illustrated in FIG. 12. The voltage of the high flying rail 710a, low flying rail 710b, and steering signal 734a are as described above with respect to FIGS. 7, 8, 10, and 11. The steering signal waveform is constant at 0.0V, because for Case D the steering signal always indicates that the regulator is to charge flying capacitor 305. Waveform 1202 illustrates the voltage appearing at the junction of buck converter high side switch 304 and buck converter low side switch 306, which is determined by the switching states described above with respect to FIG. 8. Waveform 1204 illustrates the current flowing through buck inductor 307. It can be seen that the inductor is operated in discontinuous mode using predicted switching control as described above.

For instance, at time T=13.4 μs: switch Qa (302) is turned on, pulling the high flying rail 310a voltage V(fhi) 710a up to approximately Vin and the low flying rail 310b voltage V(flo) 710b to approximately ½Vin. Then, at time T=13.6 μs, switch Q2 (306) is turned on by the inner loop controller, using its predictive algorithm, initiating the ramping of current in inductor 307, at rate (½Vin−Vout)/L. At time T=13.7 μs: switch Qa (302) is turned off, and switch Qb (308) is turned on, by outer loop charge pump controller 630. Switch Q2 (306) remains on. The voltage V(flo) 710b of low flying rail 310b transitions from approximately ½Vin to approximately 0. Now, the voltage across inductor 307 is (0−Vout)/L. Because the inductor voltage is negative, the current in inductor 307 ramps down until it hits 0 shortly after T=13.7 μs.

### Multi Output Three Level Buck Converter With Multiple Charge Pumps

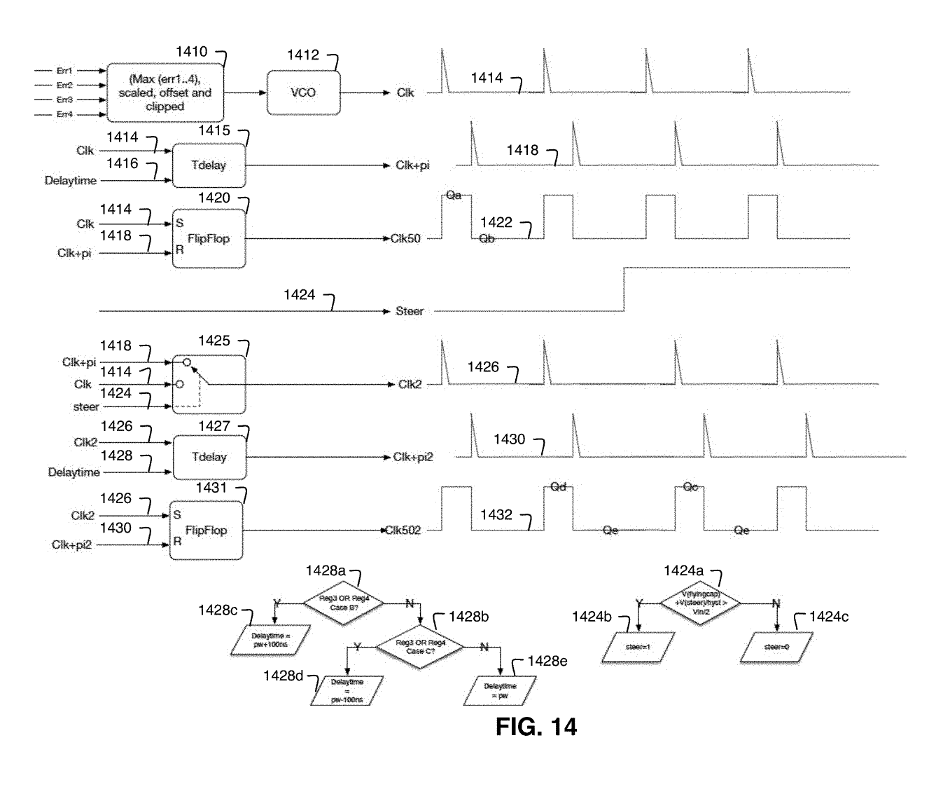

The embodiments above relate to a multi output three level buck converters having a single charge pump stage and a plurality of buck converter stages. However, in some applications, especially those with very low output voltages relative to the input voltage, it may be desirable to provide one or more additional charge pump stages. For example, a first charge pump having flying rails regulated to ½Vin may be used to power one or more buck converters having relatively higher output voltages with a second charge pump having flying rails regulated to ¼Vin may be used to power one or more buck converters having relatively lower output voltages. This may be advantageous because the losses associated with a buck converter increase with increased input voltage, so powering relatively lower voltage loads from a buck converter operating from a ¼Vin rail (rather than a ½Vin rail) may provide for improved efficiency. Such an embodiment is illustrated in FIG. 13.

FIG. 13 illustrates a multi charge pump multi output three level buck converter 1300. Converter 1300 includes a first charge pump and first and second buck stages substantially similar to those described above. It will be appreciated that a single buck converter could be provided off of this first charge pump, or more than two buck converters could be provided. Converter 1300 also includes a second charge pump made up of switches Q10 (1302), Q12 (1308), Q14 (1310) and flying capacitor 1355. Flying capacitor 1355 is connected to second flying rails 1350a and 1350b. Two additional buck converters are connected to these second flying rails 13501 and 1350b, although only one or more than two buck converters could also be provided.

Control of the multi charge pump multi output three level buck converter may be implemented using a variation of the symmetric control arrangement described above. FIG. 14 illustrates the variances between the symmetric controller described above and a symmetric controller for a multi charge pump three level buck converter as illustrated in FIG. 13. As an initial matter, each of the buck converter stages may be controlled with an individual corresponding buck controller substantially as described above. In the upper portion of FIG. 14, the error signals err1-err4, which are the error signals from each of the buck converter controllers, are input into control block 1410, which provides a signal corresponding to the maximum of these four error signals to voltage controlled oscillator 1412. Voltage controlled oscillator 1412 generates a clock signal 1414, the frequency of which is proportional to the greatest error signal from the buck converters. This clock signal 1414 and an adjustable delay time 1416 (derived as described below) are provided to a delay circuit 1415, which produces a delayed clock signal clk+pi 1418. Clock signal 1414 and delayed clock signal 1418 are provided as inputs into SR flip flop 1420 to produce clock signal 1422, which is used to control the switching of first charge pump switches Qa 302 and Qb 308 (illustrated in FIG. 13).

The middle portion of FIG. 14 illustrates steer signal 1424, which is generated and functions substantially as described above. Also, the lower right portion of FIG. 14 illustrates a flow chart showing generation of the steer signal. More specifically, at control block 1424a, it is determined whether the voltage of first charge pump flying capacitor 305 (FIG. 13) is greater than ½Vin. If so, in control block 1424b, the steer signal is set high, indicating that the downstream converters should be operated so as to discharge first charge pump flying capacitor 305. Otherwise, in control block 1424c, the steer signal is set low, indicating that the downstream converters should be operated so as to charge first charge pump flying capacitor 305.

The lower central portion of FIG. 14 illustrates generation of clock signal 1432 for control of the second charge pump switches Q10 1302 and Q12 1308 (FIG. 13). Clock signal 1414 and the delayed clock signal 1418 are provided as inputs to switch 1425. Switch 1425 is controlled by steer signal 1424 to select either the clock signal 1414 or the delayed clock signal 1418 responsive to the steer signal to generate second clock signal 1426. Second clock signal 1426, together with an adjustable delay time 1428, are provided to time delay element 1427 to generate a second delayed clock signal 1430. Adjustable delay time 1428 may be generated as described below. Second clock signal 1426 and second delayed clock signal 1430 are provided to SR flip flop 1431 to generate clock signal 1432, which is used to control the switching of second charge pump switches Q10 1302 and Q12 1308 (FIG. 13).

The lower left portion of FIG. 14 illustrates the determination of the delay time 1428, which is used to determine the duty cycles of first charge pump switches Q10 1302 and Q12 1308. In block 1428a and 1428b, it is determined whether either the third or fourth buck converters, coupled upstream of the second charge pump, are operating in either Case B (1428a) or Case C (1428c). If not, the delay time is set to a specified pulse width in block 1428e. This pulse width may be a predetermined constant, or, in some embodiments, may be a control variable used to regulate the converter. Otherwise, if either the third or fourth buck converter is operating in Case C (1428b), then the delay time is shortened by a predetermined period. In some embodiments, the predetermined period may be 100 ns. Alternatively, if either of the third or fourth buck converters are operating in Case B (1428a), then the delay time is increased by a predetermined period, for example, 100 ns. Delay time 1416 may be generated in a corresponding manner.

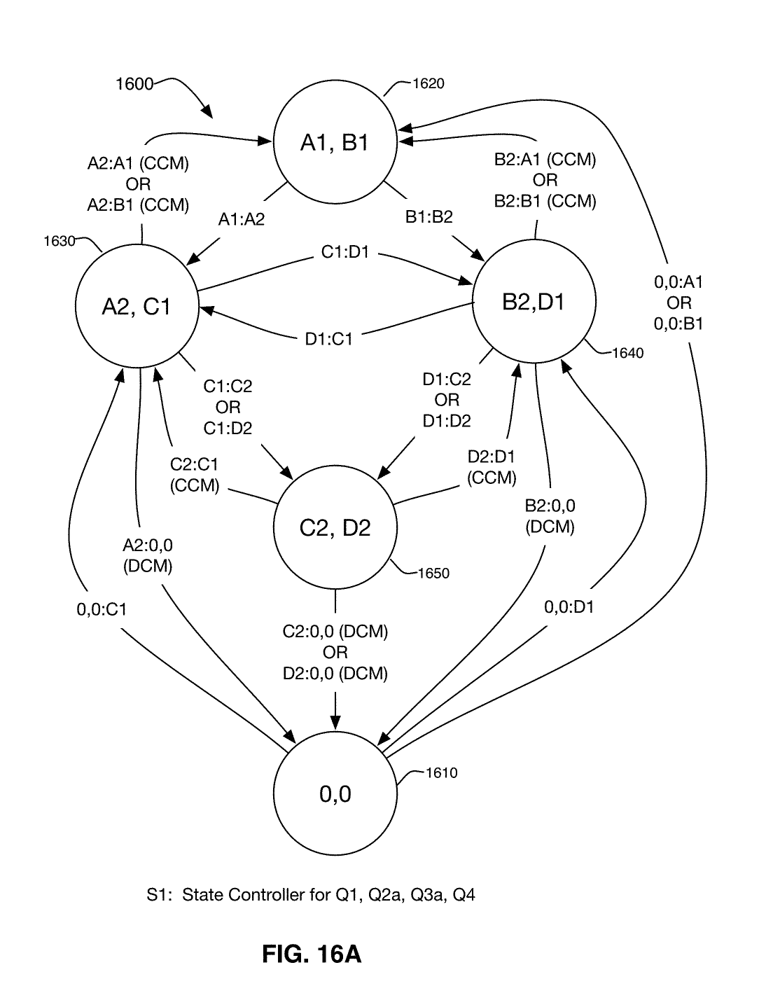

FIG. 15 illustrates the operating conditions of the second charge pump (made up of switches Q10 1302, Q12 1308, and Q14 1310 together with capacitor 1355) illustrated in FIG. 13. Cases E discharges first charge pump capacitor 305 and results in second charge pump first flying rail V(fhi2) being at roughly ½Vin and second charge pump second flying rail V(lo2) being at roughly ¼Vin. Cases F charges first charge pump capacitor 305 and results in the same second charge pump flying rail voltages as Case E. Case G decouples completely from first flying rail capacitor 305 and results in second charge pump first flying rail V(fhi2) being at roughly ¼Vin and second charge pump second flying rail V(lo2) being at roughly ground. Whether or not second flying rail capacitor 1355 is charged or discharged during these states is a function of variable steer 2 and the resulting current path of the downstream buck converters.

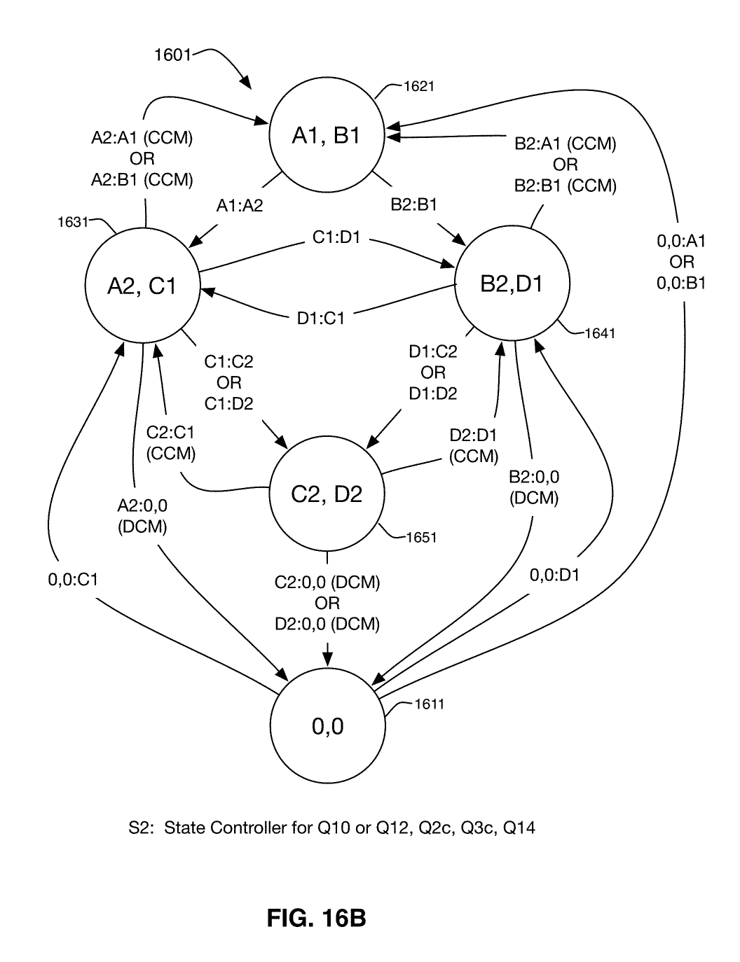

In another variation, the multi charge pump three level buck converter of FIG. 13 may be operated so that one buck converter per charge pump is operated in continuous conduction mode (CCM) as opposed to all being limited to discontinuous conduction mode (DCM), as was discussed above. FIG. 16A illustrates a state controller 1600 that may be used to operate the first charge pump (e.g., switches Qa 302 and Qb 308 together with first flying capacitor 305) and a buck converter coupled to the output of the first charge pump and able to operate in CCM or DCM (e.g., switches Q2a 304a and Q3a 306a together with inductor 307a). Remaining buck converters coupled to the output of the first charge pump (e.g., switches Q2b 304b and Q3b 306b together with inductor 307b) may be operated in DCM using a controller substantially as described above. FIG. 16B illustrates a state controller 1601 that may be used to operate the second charge pump that is coupled to the output of the first charge pump (e.g., switches Q10 1302, Q12, 1308, and Q14 1310 together with second flying capacitor 1355) and a buck converter coupled to the output of the second charge pump and able to operate in CCM or DCM (e.g., switches Q2c 304c and Q3c 306c together with inductor 307c). Although illustrated as two separate controllers, state controller 1600 and 1601 may be implemented as a single controller. Remaining buck converters coupled to the output of the second charge pump (e.g., switches Q2d 304d and Q3d 306d together with inductor 307d) may be operated in DCM using a controller substantially as described above.

As noted above, FIG. 16A illustrates a state controller 1600 that may be used to operate the first charge pump, i.e., switches Qa 302 and Qb 308 together with first flying capacitor 305 (FIG. 13) and a buck converter coupled to the output of the first charge pump and able to operate in CCM or DCM (e.g., switches Q2a 304a and Q3a 306a together with inductor 307a). State controller 1600 is analogous to the state controller discussed above with respect to FIGS. 8A and 8B, with switching states for switches Qa 302, Q2a 304a, Q3a 306a, and Qb 308 generally corresponding to those illustrated for switches Qa 302, Q1 304, Q2 306, and Qb 308 in FIG. 8B. More specifically, in state controller 1600, there are an all switches off 0,0 state 1610 and eight “active” switching states A1, A2, B1, B2, C1, C2, D1, D2 corresponding to the four Cases A, B, C, and D illustrated in FIG. 8B. As above, certain of these states correspond to the same switch positions, i.e., states A1 and B1 1620, states A2 and C1 1630, states B2 and D1 1640, and states C2 and D2 1650, which are consolidated into single “states” in FIG. 16A.

### Case A

0,0:A1-- err1>vdeadband, Vout1>Vin/2, Steer=True, clk=0

Controller 1600 can cause the switches to transition from the 0,0 state 1610 to the A1 1620 state responsive to the occurrence of four conditions:
err1>vdeadband, meaning that the buck converter output voltage has dropped below the setpoint and associated deadband (as discussed above);
Vout1>½Vin, meaning that the buck converter output voltage is greater than ½ Vin (i.e., the nominal output voltage of the first charge pump, which is the voltage across first flying capacitor 305);
Steer=True, meaning that the buck converter is being instructed to discharge flying capacitor 305 of the first charge pump; and
Clock signal 1422=0, indicating the minimum off time timer has timed out.
   In the A1 state 1620, buck converter inductor 307a is being charged from the high voltage input rail through switches Qa 302 and Q2a 304a while the charge on the flying capacitor 305 remains constant.

### A1:A2-- I(L1)>err1, Steer=True

Controller 1600 can cause the switches to transition from the A1 state 1620 to the A2 state 1630 responsive to the occurrence of two conditions:
I(L1)>err1, meaning that the current through buck inductor 307a has reached the target value specified by the peak current mode controller for the buck converter; and
Steer=True, meaning that the buck converter is being instructed to discharge flying capacitor 305 of the first charge pump.
   In the A2 state 1630, buck converter inductor 307a and first flying capacitor 305 are discharged through switches Qb 308 and Q2a 304a.

### A2:0,0 (DCM)-- I(L1)<0

Although the buck converter made up of switches Q2a 304a and Q3a 306a and inductor 307a is CCM capable, it may also operate in DCM when it is sufficiently lightly loaded. In such a case, controller 1600 can cause the switches to transition from the A2 state 1630 back to the 0,0 state 1610 responsive to the current through inductor 307a reaching zero (i.e., being completely discharged).

A2:A1 (CCM)-- err1>vdeadband, Vout1>Vin/2, Steer=True, clk=0, I(L1)>0

Alternatively, if the buck converter is sufficiently heavily loaded, the buck converter may operate in CCM. In such a case, controller 1600 can cause the switches to transition from the A2 state 1630 back to the A1 state 1620 responsive to the occurrence of four conditions:
err1>vdeadband, meaning that the buck converter output voltage has dropped below the setpoint and associated deadband;
Vout1>½Vin, meaning that the buck converter output voltage is greater than ½ Vin (i.e., the nominal output voltage of the first charge pump, which is the voltage across first flying capacitor 305);
Steer=True, meaning that the buck converter is being instructed to discharge flying capacitor 305 of the first charge pump;
Clock signal 1422=0, indicating the minimum off time timer has timed out; and
I(L1)>0, meaning that the current through inductor 307a has not reached zero.
   As above, in the A1 state 1620, the buck converter inductor is being charged from the high voltage input rail through switches Qa 302 and Q2a 304a while the charge on the flying capacitor 305 remains constant.
   A2:B1 (CCM)-- err1>vdeadband, Vout1>(Vin-Vcap), Steer=False, clk=0, I(L1)>0

While the buck converter is operating in CCM, it may be that the steer signal changes from True to False, indicating that the buck converter should be operated so as to charge flying capacitor 305 of the first charge pump. In such a case, controller 1600 can cause a transition from the A2 state 1630 to the B1 state 1620. (Recall that the switch positions for the A1 state and B1 state are the same, so the actual switching transitions are the same for either transition in the CCM mode of operation in Case A.) More specifically, the A2:B1 transition will occur responsive to the occurrence of five conditions:
err1>vdeadband, meaning that the buck converter output voltage has dropped below the setpoint and associated deadband;
Vout1>½Vin, meaning that the buck converter output voltage is greater than ½ Vin (i.e., the nominal output voltage of the first charge pump, which is the voltage across first flying capacitor 305);
Steer=False, meaning that the buck converter is now being instructed to operate so as to charge flying capacitor 305 of the first charge pump;
Clock signal 1422=0, indicating the beginning of the first charge pump's switching cycle; and
I(L1)>0; meaning that the current through inductor 307a has not reached zero.
   As above, in the B1 state 1620, the buck converter inductor is being charged from the high voltage input rail through switches Qa 302 and Q2a 304a while the charge on the flying capacitor 305 remains constant.

### Case B

0,0:B1-- err1>vdeadband, Vout1>(Vin/2), Steer=False, clk=0

Controller 1600 can cause the switches to transition from the 0,0 state 1610 to the B1 state 1620 responsive to the occurrence of four conditions:
err1>vdeadband, meaning that the buck converter output voltage has dropped below the setpoint and associated deadband (as discussed above);
Vout1>½Vin, meaning that the buck converter output voltage is greater than ½ Vin (i.e., the nominal output voltage of the first charge pump, which is the voltage across first flying capacitor 305);
Steer=False, meaning that the buck converter is being instructed to charge flying capacitor 305 of the first charge pump; and
Clock signal 1422=0, indicating the minimum off time timer has timed out.
   In the B1 state 1620, the buck converter inductor is being charged from the high voltage input rail through switches Qa 302 and Q2a 304a while the charge on the flying capacitor 305 remains constant.

### B1:B2-- I(L1)>err1, Steer=False

Controller 1600 can cause the switches to transition from the B1 state 1620 to the B2 state 1640 responsive to the occurrence of two conditions:
I(L1)>err1, meaning that the current through buck inductor 307a has reached the target value specified by the peak current mode controller for the buck converter; and
Steer=False, meaning that the buck converter is being instructed to charge flying capacitor 305 of the first charge pump.
   In the B2 state 1640, buck converter inductor 307a is discharged and first flying capacitor 305 is charged through switches Qa 302 and Q3a 306a.

### B2:0,0 (SCM)-- I(L1)<0

Although the buck converter made up of switches Q2a 304a and Q3a 306a and inductor 307a is CCM capable, it may also operate in DCM when it is sufficiently lightly loaded. In such a case, controller 1600 can cause the switches to transition from the B2 state 1640 back to the 0,0 state 1610 responsive to the current through inductor 307a reaching zero (i.e., being completely discharged).

B2:B1 (CCM)-- err1>vdeadband, Vout1>(Vin/2), Steer=False, clk=0, I(L1)>0

Alternatively, if the buck converter is sufficiently heavily loaded, the buck converter may operate in CCM. In such a case, controller 1600 can cause the switches to transition from the B2 state 1640 back to the B1 state 1620 responsive to the occurrence of four conditions:
err1>vdeadband, meaning that the buck converter output voltage has dropped below the setpoint and associated deadband;
Vout1>½Vin, meaning that the buck converter output voltage is greater than ½ Vin (i.e., the nominal output voltage of the first charge pump, which is the voltage across first flying capacitor 305);
Steer=False, meaning that the buck converter is being instructed to charge flying capacitor 305 of the first charge pump; and
Clock signal 1422=0, indicating the minimum off time timer has timed out; and
I(L1)>0, meaning that the current through inductor 307a has not reached zero.
   As above, in the B1 state 1620, the buck converter inductor is being charged from the high voltage input rail through switches Qa 302 and Q2a 304a while the charge on the flying capacitor 305 remains constant.
   B2:A1 (CCM)-- err1>vdeadband, Vout1>Vin/2, Steer=True, clk=0, I(L1)>0

As discussed above, while the buck converter is operating in CCM, it may be that the steer signal changes from False to True, indicating that the buck converter should be operated so as to discharge flying capacitor 305 of the first charge pump. In such a case, controller 1600 can cause a transition from the B2 state 1640 to the A1 state 1620. (Recall that the switch positions for the A1 state and B1 state are the same, so the actual switching transitions are the same for either transition in the CCM mode of operation in Case B.) More specifically, the B2:A1 transition will occur responsive to the occurrence of five conditions:

err1>vdeadband, meaning that the buck converter output voltage has dropped below the setpoint and associated deadband;
Vout1>½Vin, meaning that the buck converter output voltage is greater than ½ Vin (i.e., the nominal output voltage of the first charge pump, which is the voltage across first flying capacitor 305);
Steer=True, meaning that the buck converter is being instructed to discharge flying capacitor 305 of the first charge pump;
Clock signal 1422=0, indicating the minimum off time timer has timed out; and
I(L1)>0; meaning that the current through inductor 307a has not reached zero.
   As above, in the A1 state 1620, the buck converter inductor is being charged from the high voltage input rail through switches Qa 302 and Q2a 304a while the charge on the flying capacitor 305 remains constant.

### Case C

0,0:C1-- err1>vdeadband, Vout1<(Vin/2), Steer=True, clk=0

Controller 1600 can cause the switches to transition from the 0,0 state 1610 to the C1 1630 state responsive to the occurrence of four conditions:
err1>vdeadband, meaning that the buck converter output voltage has dropped below the setpoint and associated deadband;
Vout1<½Vin, meaning that the buck converter output voltage is less than ½ Vin (i.e., the nominal output voltage of the first charge pump, which is the voltage across first flying capacitor 305);
Steer=True, meaning that the buck converter is being instructed to discharge flying capacitor 305 of the first charge pump; and
Clock signal 1422=0, indicating the minimum off time timer has timed out.
   In the C1 state 1630, buck converter inductor 307a is charged and first flying capacitor 305 is discharged through switches Qb 308 and Q2a 304a.

### C1:C2-- I(L1)>err1, Vout1<Vin/2, Steer=True

If the steer signal remains true, meaning that the buck converter continues to be instructed to discharge flying capacitor 305 of the first charge pump, controller 1600 can cause a transition from the C1 state 1630 to the C2 state 1650 responsive to the occurrence of three conditions:
I(L1)>err1, meaning that the current through buck inductor 307a has reached the target value specified by the peak current mode controller for the buck converter;
Vout1<½Vin, meaning that the buck converter output voltage is less than ½ Vin (i.e., the nominal output voltage of the first charge pump, which is the voltage across first flying capacitor 305); and
Steer=True, meaning that the buck converter is being instructed to discharge flying capacitor 305 of the first charge pump.
   In the C2 state 1630, buck converter inductor 307a is discharged through switches Q3a 306a and Qb 308 while the charge on first charge pump flying capacitor 305 remains constant.

### C1:D2-- I(L1)>err, Vout1<Vin/2, Steer=False

Alternatively, if the steer signal transitions from True to False, indicating that the buck converter should be operated to charge flying capacitor 305 of the first charge pump, controller 1600 can cause a transition from the C1 state 1650 to the D2 state 1650. (It will be appreciated that the switch positions for the C2 and D2 states are identical, so the actual switching transitions are the same for either transition.) More specifically, the transition from the C1 state to the D2 state can take place on the occurrence of three conditions:
I(L1)>err1, meaning that the current through buck inductor 307a has reached the target value specified by the peak current mode controller for the buck converter;
Vout1<½Vin, meaning that the buck converter output voltage is less than ½ Vin (i.e., the nominal output voltage of the first charge pump, which is the voltage across first flying capacitor 305); and
Steer=False, meaning that the buck converter is being instructed to charge flying capacitor 305 of the first charge pump.
   In the D2 state 1630, as in the C2 state 1650, buck converter inductor 307a is discharged through switches Q3a 306a and Qb 308 while the charge on first charge pump flying capacitor 305 remains constant.

### C2:0,0 (DCM)-- I(L)<0

Although the buck converter made up of switches Q2a 304a and Q3a 306a and inductor 307a is CCM capable, it may also operate in DCM when it is sufficiently lightly loaded. In such a case, controller 1600 can cause the switches to transition from the C2 state 1650 back to the 0,0 state 1610 responsive to the current through inductor 307a reaching zero (i.e., being completely discharged).

C2:C1 (CCM)-- err1>vdeadband, Vout1<(Vin/2), Steer=True, clk=0

Alternatively, if the buck converter is sufficiently heavily loaded, the buck converter may operate in CCM. In such a case, controller 1600 can cause the switches to transition from the C2 state 1650 back to the C1 state 1630 responsive to the occurrence of four conditions:
err1>vdeadband, meaning that the buck converter output voltage has dropped below the setpoint and associated deadband;
Vout1<½Vin, meaning that the buck converter output voltage is less than ½ Vin (i.e., the nominal output voltage of the first charge pump, which is the voltage across first flying capacitor 305);
Steer=True, meaning that the buck converter is being instructed to discharge flying capacitor 305 of the first charge pump; and
Clock signal 1422=0, indicating the minimum off time timer has timed out.
   As above, in the C1 state 1630, buck converter inductor 307a is charged and first flying capacitor 305 is discharged through switches Qb 308 and Q2a 304a.

### Case D

0,0:D1-- err1>vdeadband, Vout1<(Vin/2), Steer=False, clk=0

Controller 1600 can cause the switches to transition from the 0,0 state 1610 to the D1 1640 state responsive to the occurrence of four conditions:
err1>vdeadband, meaning that the buck converter output voltage has dropped below the setpoint and associated deadband;
Vout1<½Vin, meaning that the buck converter output voltage is less than ½ Vin (i.e., the nominal output voltage of the first charge pump, which is the voltage across first flying capacitor 305);
Steer=False, meaning that the buck converter is being instructed to charge flying capacitor 305 of the first charge pump; and
Clock signal 1422=0, indicating the minimum offtime timer has timed out.
   In the D1 state 1640, buck converter inductor 307a and first flying capacitor 305 are charged through switches Qa 302 and Q3a 306a.

### D1:D2-- I(L1)>err1, Vout1<(Vin/2), Steer=False

If the steer signal remains False, indicating that the buck converter should be operated to charge flying capacitor 305 of the first charge pump, controller 1600 can cause a transition from the D1 state 1650 to the D2 state 1650. More specifically, the transition from the D1 state to the D2 state can take place on the occurrence of three conditions:
I(L1)>err1, meaning that the current through buck inductor 307a has reached the target value specified by the peak current mode controller for the buck converter;
Vout1<½Vin, meaning that the buck converter output voltage is less than ½ Vin (i.e., the nominal output voltage of the first charge pump, which is the voltage across first flying capacitor 305); and
Steer=False, meaning that the buck converter is being instructed to charge flying capacitor 305 of the first charge pump.
   In the D2 state 1650, as in the C2 state 1650, buck converter inductor 307a is discharged through switches Q3a 306a and Qb 308 while the charge on first charge pump flying capacitor 305 remains constant.

### D1:C2-- I(L1)>err1, Vout1<(Vin/2), Steer=True

If the steer signal transitions from False to True, meaning that the buck converter continues to be instructed to discharge flying capacitor 305 of the first charge pump, controller 1600 can cause a transition from the D1 state 1630 to the C2 state 1650. (It will be appreciated that the switch positions for the C2 and D2 states are identical, so the actual switching transitions are the same for either transition.) More specifically, the transition from the D1 state 1630 to the C2 state 1650 can occur responsive to the occurrence of three conditions:
I(L1)>err1, meaning that the current through buck inductor 307a has reached the target value specified by the peak current mode controller for the buck converter;
Vout1<½Vin, meaning that the buck converter output voltage is less than ½ Vin (i.e., the nominal output voltage of the first charge pump, which is the voltage across first flying capacitor 305); and
Steer=True, meaning that the buck converter is being instructed to discharge flying capacitor 305 of the first charge pump.
   In the C2 state 1630, buck converter inductor 307a is discharged through switches Q3a 306a and Qb 308 while the charge on first charge pump flying capacitor 305 remains constant.

### D2:0,0 (DCM)-- I(L)<0

Although the buck converter made up of switches Q2a 304a and Q3a 306a and inductor 307a is CCM capable, it may also operate in DCM when it is sufficiently lightly loaded. In such a case, controller 1600 can cause the switches to transition from the D2 state 1650 back to the 0,0 state 1610 responsive to the current through inductor 307a reaching zero (i.e., being completely discharged).

D2:D1 (CCM)-- err1>vdeadband, Vout1<(Vin/2), Steer=False, clk=0

Alternatively, if the buck converter is sufficiently heavily loaded, the buck converter may operate in CCM. In such a case, controller 1600 can cause the switches to transition from the D2 state 1650 back to the D1 state 1640 responsive to the occurrence of four conditions:
err1>vdeadband, meaning that the buck converter output voltage has dropped below the setpoint and associated deadband;
Vout<½Vin, meaning that the buck converter output voltage is less than ½ Vin (i.e., the nominal output voltage of the first charge pump, which is the voltage across first flying capacitor 305);
Steer=False, meaning that the buck converter is being instructed to charge flying capacitor 305 of the first charge pump; and
Clock signal 1422=0, indicating the minimum off time timer has timed out.
   As above, in the D1 state 1640, buck converter inductor 307a and first flying capacitor 305 are charged through switches Qa 302 and Q3a 306a.
   D1:C1-- err1>vdeadband, Vout1<Vin/2, Steer=True, clk=0, I(L1)<err1

As discussed briefly above, while operating in Case D, if inductor 307a does not sufficiently charge during state D1 1640, controller 1600 can transition to state C1 1630 when clock signal 1422 transitions to zero, indicating the beginning of the first charge pump's switching cycle. This can allow output inductor 307a to continue charging, now from flying capacitor 305, to ensure sufficient energy is transferred to the output of the buck converter. As noted above, this prioritizes buck converter output voltage regulation (which is typically more important) over flying capacitor voltage regulation (which is typically less important). This additional state transition may be omitted if, in some application, flying capacitor voltage regulation were more important than buck converter output voltage regulation. Once the buck converter controller has transitioned from state D1 1640 to state C1 1630, it will either transition to state C2 1650 and so on, as described above (assuming the inductor is eventually fully charged) or it will transition back to state D1 1640 as described below.

C1:D1-- err1>vdeadband, Vout1<(Vin/2), Steer=False, clk=0, I(L1)<err1

Ordinarily in state C1 1630, controller 1600 will transition to state C2 1650 based on peak current control of inductor 307a as described above. However, in some cases (e.g., when Vout is very close to ½Vin) it may be possible for the inductor to charge sufficiently slowly that it does not reach its current target before both the ‘steer’ signal changes state and the timer times out. In that case, the controller will transition from state C1 1630 to state D1 1640.

As noted above, FIG. 16B illustrates a state controller 1601 that may be used to operate the second charge pump (e.g., switches Q10 1302, Q12 1308, and Q14 1310 together with second flying capacitor 1355) and a buck converter coupled to the output of the second charge pump and able to operate in CCM or DCM (e.g., switches Q2c 304c and Q3c 306c together with inductor 307c). State controller 1601 is analogous to state controller 1600 discussed above with reference to FIG. 16A. In this case, the switching states for charge pump high side switches Q10 1302 and Q12 1308 correspond to the switching state for Qa 302; the switching states for buck converter switches Q2c 304c and Q3c 306c correspond to the switching states for buck converter switches Q2a 304a and Q3a 306a; and the switching states for charge pump low side switch Q14 1310 corresponds to the switching state for Qb 308. As above, in state controller 1601, there are an all switches off 0,0 state 1610 and eight “active” switching states A1, A2, B1, B2, C1, C2, D1, D2 corresponding to the four Cases A, B, C, and D illustrated in FIG. 8B as modified by the states E, F, and G, illustrated in FIG. 15. As above, certain of these states correspond to the same switch positions, i.e., states A1 and B1 1621, states A2 and C1 1631, states B2 and D1 1641, and states C2 and D2 1651, which are consolidated into single “states” in FIG. 16B.

### Case A

0,0:A1-- err3>vdeadband, Vout3>(Vin/4), Steer2=True, clk=0

Controller 1601 can cause the switches to transition from the 0,0 state 1610 to the A1 1621 state responsive to the occurrence of four conditions:
err3>vdeadband, meaning that the buck converter output voltage has dropped below the setpoint and associated deadband (as discussed above);
Vout3>¼Vin, meaning that the buck converter output voltage is greater than ¼Vin (i.e., the nominal output voltage of the second charge pump, which is the voltage across second flying capacitor 1355);
Steer2=True, meaning that the buck converter is being instructed to discharge flying capacitor 1355 of the second charge pump; and
Clock signal 1432=0, indicating the minimum off time timer has timed out.
   In the A1 state 1621, buck converter inductor 307c is being charged from the second charge pump's high voltage input rail through switch Q10 1302 or Q12 1308 (depending on the switching state E or F of the second charge pump) and switch Q2c 304c while the charge on the flying capacitor 1355 remains constant.

### A1:A2-- I(L3)>err3, Steer2=True

Controller 1601 can cause the switches to transition from the A1 state 1621 to the A2 state 1631 responsive to the occurrence of two conditions:
I(L3)>err3, meaning that the current through buck inductor 307c has reached the target value specified by the peak current mode controller for the buck converter; and
Steer2=True, meaning that the buck converter is being instructed to discharge flying capacitor 1355 of the second charge pump.
   In the A2 state 1631, buck converter inductor 307c and second flying capacitor 1355 are discharged through switches Q14 1310 and Q2c 304c.

### A2:0,0 (SCM)-- I(L)<0

Although the buck converter made up of switches Q2c 304c and Q3c 306c and inductor 307c is CCM capable, it may also operate in DCM when it is sufficiently lightly loaded. In such a case, controller 1601 can cause the switches to transition from the A2 state 1631 back to the 0,0 state 1611 responsive to the current through inductor 307c reaching zero (i.e., being completely discharged).

A2:A1 (CCM)-- err3>vdeadband, Vout3>(Vin/4), Steer2=True, clk=0, I(L3)>0

Alternatively, if the buck converter is sufficiently heavily loaded, the buck converter may operate in CCM. In such a case, controller 1601 can cause the switches to transition from the A2 state 1631 back to the A1 state 1621 responsive to the occurrence of four conditions:
err3>vdeadband, meaning that the buck converter output voltage has dropped below the setpoint and associated deadband;
Vout3>¼Vin, meaning that the buck converter output voltage is greater than ¼Vin (i.e., the nominal output voltage of the second charge pump, which is the voltage across second flying capacitor 1355);
Steer2=True, meaning that the buck converter is being instructed to discharge flying capacitor 1355 of the second charge pump;
Clock signal 1432=0, indicating the minimum off time timer has timed out; and
I(L3)>0, meaning that the current through inductor 307c has not reached zero.
   As above, in the A1 state 1621, buck converter inductor 307c is being charged from the second charge pump's high voltage input rail through switch Q10 1302 or Q12 1308 (depending on the switching state E or F of the second charge pump) and switch Q2c 304c while the charge on the flying capacitor 1355 remains constant.
   A2:B 1 (CCM)-- err3>vdeadband, Vout3>(Vin/4), Steer2=False, clk=0, I(L3)>0

While the buck converter is operating in CCM, it may be that the steer signal changes from True to False, indicating that the buck converter should be operated so as to charge flying capacitor 1355 of the second charge pump. In such a case, controller 1601 can cause a transition from the A2 state 1631 to the B1 state 1621. (Recall that the switch positions for the A1 state and B1 state are the same, so the actual switching transitions are the same for either transition in the CCM mode of operation in Case A.) More specifically, the A2:B1 transition will occur responsive to the occurrence of five conditions:
err3>vdeadband, meaning that the buck converter output voltage has dropped below the setpoint and associated deadband;
Vout3>¼Vin, meaning that the buck converter output voltage is greater than ¼Vin (i.e., the nominal output voltage of the second charge pump, which is the voltage across second flying capacitor 1355);
Steer2=False, meaning that the buck converter is now being instructed to operate so as to charge flying capacitor 1355 of the second charge pump;
Clock signal 1432=0, indicating the minimum off time timer has timed out; and
I(L3)>0; meaning that the current through inductor 307c has not reached zero.
   In the B1 state 1621, buck converter inductor 307c is being charged from the second charge pump's high voltage input rail through switch Q10 1302 or Q12 1308 (depending on the switching state E or F of the second charge pump) and switch Q2c 304c while the charge on the flying capacitor 1355 remains constant.

Case B

0,0:B1-- err3>vdeadband, Vout3>(Vin/4), Steer2=False, clk=0

Controller 1601 can cause the switches to transition from the 0,0 state 1611 to the B1 state 1621 responsive to the occurrence of four conditions:
err3>vdeadband, meaning that the buck converter output voltage has dropped below the setpoint and associated deadband (as discussed above);
Vout3>¼Vin, meaning that the buck converter output voltage is greater than ¼Vin (i.e., the nominal output voltage of the second charge pump, which is the voltage across second flying capacitor 1355);
Steer2=False, meaning that the buck converter is being instructed to charge flying capacitor 1355 of the second charge pump; and
Clock signal 1432=0, indicating the beginning of the second charge pump's switching cycle.
   In the B1 state 1621, buck converter inductor 307c is being charged from the second charge pump's high voltage input rail through switch Q10 1302 or Q12 1308 (depending on the switching state E or F of the second charge pump) and switch Q2c 304c while the charge on the flying capacitor 1355 remains constant.

### B1:B2-- I(L3)>err, Steer2=False

Controller 1601 can cause the switches to transition from the B1 state 1621 to the B2 state 1641 responsive to the occurrence of two conditions:
I(L3)>err3, meaning that the current through buck inductor 307c has reached the target value specified by the peak current mode controller for the buck converter; and
Steer2=False, meaning that the buck converter is being instructed to charge flying capacitor 355 of the second charge pump.
   In the B2 state 1641, buck converter inductor 307c is discharged and second flying capacitor 1355 is charged through switch Q10 1302 or Q12 1308 (depending on the switching state E or F of the second charge pump) and switch Q3c 306c.

### B2:0,0 (DCM)-- I(L)<0

Although the buck converter made up of switches Q2c 304c and Q3c 306c and inductor 307c is CCM capable, it may also operate in DCM when it is sufficiently lightly loaded. In such a case, controller 1601 can cause the switches to transition from the B2 state 1641 back to the 0,0 state 1611 responsive to the current through inductor 307c reaching zero (i.e., being completely discharged).

B2:B1 (CCM)-- err3>vdeadband, Vout3>(Vin/4), Steer2=False, clk=0, I(L3)>0

Alternatively, if the buck converter is sufficiently heavily loaded, the buck converter may operate in CCM. In such a case, controller 1601 can cause the switches to transition from the B2 state 1641 back to the B1 state 1621 responsive to the occurrence of four conditions:
err3>vdeadband, meaning that the buck converter output voltage has dropped below the setpoint and associated deadband;
Vout3>¼Vin, meaning that the buck converter output voltage is greater than ¼Vin (i.e., the nominal output voltage of the second charge pump, which is the voltage across second flying capacitor 1355);
Steer2=False, meaning that the buck converter is being instructed to charge flying capacitor 1355 of the second charge pump; and
Clock signal 1432=0, indicating the minimum off time timer has timed out; and
I(L3)>0, meaning that the current through inductor 307c has not reached zero.
   As above, in the B1 state 1621, buck converter inductor 307c is being charged from the second charge pump's high voltage input rail through switch Q10 1302 or Q12 1308 (depending on the switching state E or F of the second charge pump) and switch Q2c 304c while the charge on the flying capacitor 1355 remains constant.
   B2:A1 (CCM)-- err3>vdeadband, Vout3>(Vin/4), Steer2=True, clk=0, I(L3)>0

As discussed above, while the buck converter is operating in CCM, it may be that the steer signal changes from False to True, indicating that the buck converter should be operated so as to discharge flying capacitor 1355 of the second charge pump. In such a case, controller 1601 can cause a transition from the B2 state 1641 to the A1 state 1621. (Recall that the switch positions for the A1 state and B1 state are the same, so the actual switching transitions are the same for either transition in the CCM mode of operation in Case B.) More specifically, the B2:A1 transition will occur responsive to the occurrence of five conditions:
err3>vdeadband, meaning that the buck converter output voltage has dropped below the setpoint and associated deadband;
Vout3>¼Vin, meaning that the buck converter output voltage is greater than ¼Vin (i.e., the nominal output voltage of the second charge pump, which is the voltage across second flying capacitor 1355);
Steer2=True, meaning that the buck converter is being instructed to discharge flying capacitor 1355 of the second charge pump;
Clock signal 1432=0, indicating the minimum off time timer has timed out; and
I(L3)>0; meaning that the current through inductor 307c has not reached zero.
   As above, in the A1 state 1621, buck converter inductor 307c is being charged from the second charge pump's high voltage input rail through switch Q10 1302 or Q12 1308 (depending on the switching state E or F of the second charge pump) and switch Q2c 304c while the charge on the flying capacitor 1355 remains constant.

Case C

0,0:C1-- err3>vdeadband, Vout3<(Vin/4), Steer2=True, clk=0

Controller 16010 can cause the switches to transition from the 0,0 state 1611 to the C1 1631 state responsive to the occurrence of four conditions:
err3>vdeadband, meaning that the buck converter output voltage has dropped below the setpoint and associated deadband;
Vout3<¼Vin, meaning that the buck converter output voltage is less than ¼Vin (i.e., the nominal output voltage of the second charge pump, which is the voltage across second flying capacitor 1355);
Steer2=True, meaning that the buck converter is being instructed to discharge flying capacitor 1355 of the first charge pump; and
Clock signal 1432=0, indicating the minimum off time timer has timed out.
   In the C1 state 1631, buck converter inductor 307c is charged and second flying capacitor 1355 is discharged through switches Q14 1310 and Q2c 304c.

### C1:C2-- I(L3)>err3, Vout3<(Vin/4), Steer2=True

If the steer signal remains true, meaning that the buck converter continues to be instructed to discharge flying capacitor 1355 of the second charge pump, controller 1601 can cause a transition from the C1 state 1631 to the C2 state 1651 responsive to the occurrence of three conditions:
I(L3)>err3, meaning that the current through buck inductor 307c has reached the target value specified by the peak current mode controller for the buck converter;
Vout3<¼Vin, meaning that the buck converter output voltage is less than ¼Vin (i.e., the nominal output voltage of the second charge pump, which is the voltage across second flying capacitor 1355); and
Steer2=True, meaning that the buck converter is being instructed to discharge flying capacitor 1355 of the second charge pump.
   In the C2 state 1631, buck converter inductor 307c is discharged through switches Q3c 306c and Q14 1310 while the charge on second charge pump flying capacitor 1355 remains constant.

### C1:D2-- I(L3)>err3, Vout3<(Vin/4), Steer2=False

Alternatively, if the steer2 signal transitions from True to False, indicating that the buck converter should be operated to charge flying capacitor 1355 of the second charge pump, controller 1601 can cause a transition from the C1 state 1651 to the D2 state 1651. (It will be appreciated that the switch positions for the C2 and D2 states are identical, so the actual switching transitions are the same for either transition.) More specifically, the transition from the C1 state to the D2 state can take place on the occurrence of three conditions:
I(L3)>err3, meaning that the current through buck inductor 307a has reached the target value specified by the peak current mode controller for the buck converter;
Vout3<¼Vin, meaning that the buck converter output voltage is less than ¼Vin (i.e., the nominal output voltage of the second charge pump, which is the voltage across second flying capacitor 1355); and
Steer2=False, meaning that the buck converter is being instructed to charge flying capacitor 1355 of the second charge pump.
   In the D2 state 1631, as in the C2 state 1651, buck converter inductor 307c is discharged through switches Q3a 306a and Q14 1310 while the charge on second charge pump flying capacitor 1355 remains constant.

### C2:0,0 (DCM)-- I(L)<0

Although the buck converter made up of switches Q2c 304c and Q3c 306c and inductor 307c is CCM capable, it may also operate in DCM when it is sufficiently lightly loaded. In such a case, controller 1601 can cause the switches to transition from the C2 state 1651 back to the 0,0 state 1611 responsive to the current through inductor 307c reaching zero (i.e., being completely discharged).

C2:C1 (CCM)-- err3>vdeadband, Vout3<(Vin/4), Steer2=True, clk=0

Alternatively, if the buck converter is sufficiently heavily loaded, the buck converter may operate in CCM. In such a case, controller 1601 can cause the switches to transition from the C2 state 1651 back to the C1 state 1631 responsive to the occurrence of four conditions:
err3>vdeadband, meaning that the buck converter output voltage has dropped below the setpoint and associated deadband;
Vout3<¼Vin, meaning that the buck converter output voltage is less than ¼Vin (i.e., the nominal output voltage of the second charge pump, which is the voltage across second flying capacitor 1355);
Steer2=True, meaning that the buck converter is being instructed to discharge flying capacitor 1355 of the second charge pump; and
Clock signal 1432=0, indicating the minimum off time timer has timed out.
   As above, in the C1 state 1631, buck converter inductor 307c is charged and second flying capacitor 1355 is discharged through switches Q14 1310 and Q2c 304c.

Case D

0,0:D1-- err3>vdeadband, Vout3<(Vin/4), Steer2=False, clk=0

Controller 1601 can cause the switches to transition from the 0,0 state 1611 to the D1 1641 state responsive to the occurrence of four conditions:
err3>vdeadband, meaning that the buck converter output voltage has dropped below the setpoint and associated deadband;
Vout3<¼Vin, meaning that the buck converter output voltage is less than ¼Vin (i.e., the nominal output voltage of the second charge pump, which is the voltage across second flying capacitor 1355);
Steer2=False, meaning that the buck converter is being instructed to charge flying capacitor 1355 of the second charge pump; and
Clock signal 1422=0, indicating the minimum off time timer has timed out.
   In the D1 state 1641, buck converter inductor 307c and second flying capacitor 1355 are charged through switch Q10 1302 or Q12 1308 (depending on the switching state E or F of the second charge pump) and switch Q3c 306c.

### D1:D2-- I(L3)>err3, Vout3<(Vin/4), Steer2=False

If the steer signal remains False, indicating that the buck converter should be operated to charge flying capacitor 1355 of the second charge pump, controller 1601 can cause a transition from the D1 state 1651 to the D2 state 1651. More specifically, the transition from the D1 state to the D2 state can take place on the occurrence of three conditions:
I(L3)>err3, meaning that the current through buck inductor 307c has reached the target value specified by the peak current mode controller for the buck converter;
Vout3<¼Vin, meaning that the buck converter output voltage is less than ¼Vin (i.e., the nominal output voltage of the second charge pump, which is the voltage across second flying capacitor 1355); and
Steer2=False, meaning that the buck converter is being instructed to charge flying capacitor 1355 of the second charge pump.
   In the D2 state 1651, as in the C2 state 1651, buck converter inductor 307c is discharged through switches Q3c 306c and Q14 1310 while the charge on second charge pump flying capacitor 1355 remains constant.

### D1:C2-- I(L3)>err3, Vout3<(Vin/4), Steer2=True

If the steer signal transitions from False to True, meaning that the buck converter continues to be instructed to discharge flying capacitor 305 of the first charge pump, controller 1600 can cause a transition from the D1 state 1631 to the C2 state 1651. (It will be appreciated that the switch positions for the C2 and D2 states are identical, so the actual switching transitions are the same for either transition.) More specifically, the transition from the D1 state 1631 to the C2 state 1651 can occur responsive to the occurrence of three conditions:
I(L3)>err3, meaning that the current through buck inductor 307c has reached the target value specified by the peak current mode controller for the buck converter;
Vout3<¼Vin, meaning that the buck converter output voltage is less than ¼Vin (i.e., the nominal output voltage of the second charge pump, which is the voltage across second flying capacitor 1355); and
Steer2=True, meaning that the buck converter is being instructed to discharge flying capacitor 1355 of the second charge pump.
   In the C2 state 1631, buck converter inductor 307c is discharged through switches Q3c 306c and Q14 1310 while the charge on second charge pump flying capacitor 1355 remains constant.

### D2:0,0 (DCM)-- I(L)<0

Although the buck converter made up of switches Q2c 304c and Q3c 306c and inductor 307c is CCM capable, it may also operate in DCM when it is sufficiently lightly loaded. In such a case, controller 1601 can cause the switches to transition from the D2 state 1651 back to the 0,0 state 1611 responsive to the current through inductor 307c reaching zero (i.e., being completely discharged).

D2:D1 (CCM)-- err3>vdeadband, Vout3<(Vin/4), Steer2=False, clk=0

Alternatively, if the buck converter is sufficiently heavily loaded, the buck converter may operate in CCM. In such a case, controller 1601 can cause the switches to transition from the D2 state 1651 back to the D1 state 1641 responsive to the occurrence of four conditions:
err3>vdeadband, meaning that the buck converter output voltage has dropped below the setpoint and associated deadband;
Vout3<¼Vin, meaning that the buck converter output voltage is less than ¼Vin (i.e., the nominal output voltage of the second charge pump, which is the voltage across second flying capacitor 355);
Steer2=False, meaning that the buck converter is being instructed to charge flying capacitor 1355 of the second charge pump; and
Clock signal 1432=0, indicating the minimum off time timer has timed out.
   As above, in the D1 state 1641, buck converter inductor 307c and second flying capacitor 1355 are charged through switch Q10 1302 or Q12 1308 (depending on the switching state E or F of the second charge pump) and switch Q3c 306c.

D1:C1-- err3>vdeadband, Vout3<(Vin/4), Steer2=True, clk=0, I(L3)<err3

As discussed briefly above, while operating in Case D, if inductor 307c does not sufficiently charge during state D1 1641 (e.g., when Vout is very close to ½Vin), controller 1601 can transition to state C1 1631 when both the steer2 signal changes state, and the clock signal 1432 transitions to zero, indicating the timer has timed out. This can allow output inductor 307c to continue charging, now from flying capacitor 1355, to ensure sufficient energy is transferred to the output of the buck converter. Once the buck converter controller has transitioned from state D1 1641 to state C1 1631, it will either transition to state C2 1651 and so on, as described above (assuming the inductor is eventually fully charged) or it will transition back to state D1 1641 as described below.

C1:D1-- err3>vdeadband, Vout3<(Vin/4), Steer2=False, clk=0, I(L3)<err3

Ordinarily in state C2 1631, controller 1601 will transition to state C2 1651 based on peak current control of inductor 307c as described above. However, in some cases (e.g., when Vout is very close to ¼Vin) it may be possible for the inductor to charge sufficiently slowly that it does not reach its current target before both the ‘steer’ signal changes state and the timer times out. In that case, the controller will transition from state C2 1631 to state D1 1641.

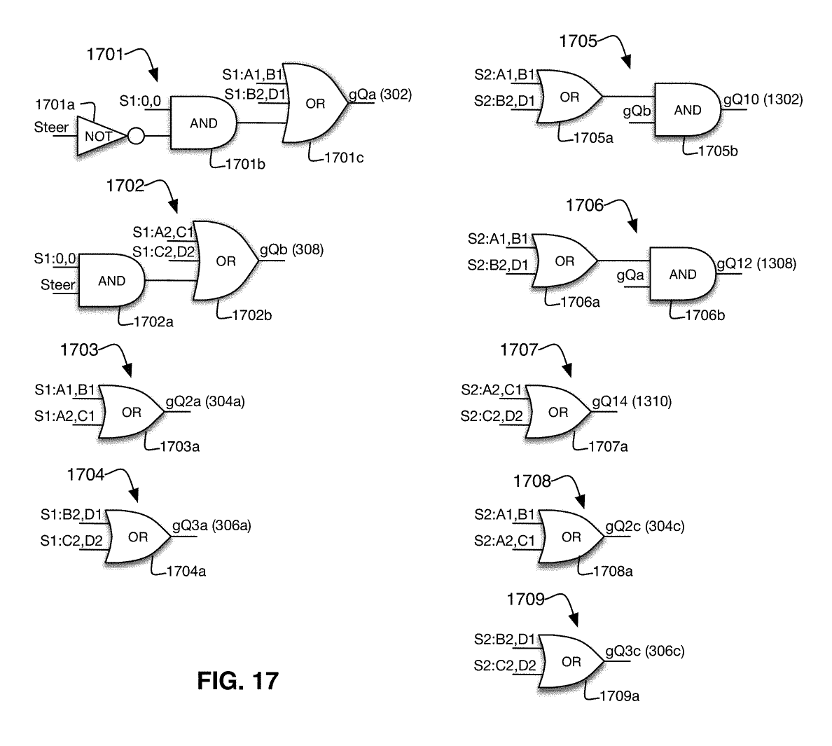

FIG. 17 depicts a series of logic circuits 1701-1709 that may be used in conjunction with the state controllers illustrated in FIGS. 16A and 16B to trigger the gates of the respective switching devices of the multi output three level buck converter with multiple charge pumps and one CCM capable buck converter per charge pump.

Logic circuit 1701 may be used to trigger a gate of first charge pump high side switch Qa 302 (FIG. 13). The logic circuit comprises a NOT or inverter 1701a that receives the steer signal discussed above. The inverted steer signal and a signal indicating that state controller 1600 (FIG. 16A) is in the 0,0 state 1610 (FIG. 16A) are input into AND gate 1701b. The output of AND gate 1701b is input into OR gate 1701c, which has two other inputs indicating that state controller 1600 is in the A1,B1 state (1620) or the B2,D1 state 1640. If any of these conditions is true, the output of OR gate will transition high, which may be used to trigger the gate of first charge pump high side switch Qa 302.

Logic circuit 1702 may be used to trigger a gate of first charge pump low side switch Qb 308 (FIG. 13). The logic circuit comprises an AND gate 1702a that receives two input signals: (1) the steer signal discussed above and (2) a signal indicating that state controller 1600 (FIG. 16A) is in the 0,0 state 1610. The output of AND gate 1702A is fed as an input to OR gate 1702b, which also receives two other input signals: (1) a signal indicating that state controller 1600 is in the A2,C1 state 1630 and (2) a signal indicating that state controller 1600 is in the C2,D2 state 1650. If any of these conditions is true, the output of OR gate 1702b will transition high, which may be used to trigger the gate of first charge pump low side switch Qb 308.

Logic circuit 1703 may be used to trigger a gate of high side switch Q2a 304a (FIG. 13) of a CCM-capable buck converter coupled to the output of the first charge pump. Logic circuit 1703 includes an OR gate 1703a that receives two input signals (1) an indication that state controller 1600 (FIG. 16A) is in the A1,B1 state 1620 and (2) an indication that state controller 1600 is in the A2,C1 state 1630. If either of these conditions is true, the output of OR gate 1703a will transition high, which may be used to trigger the gate of CCM capable buck high side switch Q2a 304a.

Logic circuit 1704 may be used to trigger a gate of low side switch Q3a 306a (FIG. 13) of a CCM-capable buck converter coupled to the output of the first charge pump. Logic circuit 1704 includes an OR gate 1704a that receives two input signals (1) an indication that state controller 1600 (FIG. 16A) is in the B2,D1 state 1640 and (2) an indication that state controller 1600 is in the C2,D2 state 1650. If either of these conditions is true, the output of OR gate 1704a will transition high, which may be used to trigger the gate of CCM capable buck low side switch Q3a 306a.

Logic circuit 1705 may be used to trigger a gate of second charge pump first side switch Q10 1302 (FIG. 13). Logic circuit 1705 includes OR gate 1705a that receives two input signals: (1) a signal indicating that state controller 1602 (FIG. 16B) is in the A1,B1 state 1621 and (2) a signal indicating that state controller 1602 is in the B2,D1 state 1641. If either of these conditions are true, a high signal is passed to one input of AND gate 1705b. AND gate 1705b receives as its other input the Qb (308) drive signal that is the output of logic circuit 1702 discussed above. If both of these signals are high, AND gate 1705b will output a signal triggering the gate of second charge pump high side switch Q10 1302.

Logic circuit 1706 may be used to trigger a gate of second charge pump second high side switch Q12 1308 (FIG. 13). Logic circuit 1706 includes OR gate 1706a that receives two input signals: (1) a signal indicating that state controller 1602 (FIG. 16B) is in the A1,B1 state 1621 and (2) a signal indicating that state controller 1602 is in the B2,D1 state 1641. If either of these conditions are true, a high signal is passed to one input of AND gate 1706b. AND gate 1706b receives as its other input the Qa (302) drive signal that is the output of logic circuit 1701 discussed above. If both of these signals are high, AND gate 1706b will output a signal triggering the gate of second charge pump second high side switch Q11 1308.

Logic circuit 1707 may be used to trigger a gate of second charge pump low side switch Q14 1310 (FIG. 13). Logic circuit 1707 includes OR gate 1707a that receives two input signals: (1) a signal indicating that state controller 1602 (FIG. 16B) is in the A2,C1 state 1631 and (2) a signal indicating that state controller 1602 is in the C2,D2 state 1651. If either of these conditions are true, OR gate 1707a will output a signal triggering the gate of second charge pump low side switch Q14 1310.

Logic circuit 1708 may be used to trigger a gate of high side switch Q2c 304c (FIG. 13) of a CCM-capable buck converter coupled to the output of the second charge pump. Logic circuit 1708 includes an OR gate 1708a that receives two input signals (1) an indication that state controller 1601 (FIG. 16B) is in the A1,B1 state 1621 and (2) an indication that state controller 1601 is in the A2,C1 state 1631. If either of these conditions is true, the output of OR gate 1708a will transition high, which may be used to trigger the gate of CCM capable buck high side switch Q2c 304c.

Logic circuit 1709 may be used to trigger a gate of low side switch Q3c 306c (FIG. 13) of a CCM-capable buck converter coupled to the output of the first charge pump. Logic circuit 1709 includes an OR gate 1709a that receives two input signals (1) an indication that state controller 1601 (FIG. 16B) is in the B2,D1 state 1641 and (2) an indication that state controller 1601 is in the C2,D2 state 1651. If either of these conditions is true, the output of OR gate 1709a will transition high, which may be used to trigger the gate of CCM capable buck low side switch Q3c 306c.

Described above are various features and embodiments relating to multi output three level buck converters. Such converters may be used in a variety of applications, but may be particular advantageous when used in conjunction with portable electronic devices such as mobile telephones, smart phones, tablet computers, laptop computers, media players, and the like, as well as the peripherals associated therewith. Such associated peripherals can include input devices (such as keyboards, mice, touchpads, tablets, microphones and the like), output devices (such as headphones or speakers), combination input/output devices (such as combined headphones and microphones), storage devices, or any other peripheral. Other applications can include on-chip point of load regulators.

Additionally, although numerous specific features and various embodiments have been described, it is to be understood that, unless otherwise noted as being mutually exclusive, the various features and embodiments may be combined in any of the various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A power converter comprising:
a charge pump configured to receive an input voltage and generate a flying rail voltage therefrom; and
a plurality of buck converters each configured to generate a regulated output voltage from the flying rail voltage.

2. The power converter of claim 1 further comprising an asymmetric controller, the asymmetric controller comprising:
a first controller coupled to the charge pump a first buck converter of the plurality of buck converters, wherein the first control loop is configured to control the flying rail voltage and the regulated output voltage of the first buck converter; and
a second controller coupled to a second of the plurality of buck converters, wherein the second control loop is configured to control the regulated output voltage of the second buck converter.

3. The power converter of claim 1 wherein the first controller is a constant on time pulse frequency modulation controller.

4. The power converter of claim 1 further comprising a symmetric controller, the symmetric controller comprising:
an outer control loop; and
a plurality of inner control loops in communication with the outer control loop, each inner control loop configured to control one of the plurality of buck converters to generate a respective regulated output voltage and responsive to one or more signals received from the outer control loop to draw power from or return power to the charge pump.

5. The power converter of claim 4 wherein the outer control loop comprises a hysteretic controller.

7. The power converter of claim 6 wherein at least one of the plurality of inner control loops is configured to cause a corresponding buck converter to generate a respective regulated output voltage that may be greater than or less than the flying rail voltage.

8. The power converter of claim 1 wherein:
the charge pump configured to receive an input voltage and generate a flying rail voltage therefrom comprises:
a first charge pump coupled between an input of the power converter and a first pair of flying rails and configured to generate a first flying rail voltage across the first pair of flying rails; and
a second charge pump coupled between the first pair of flying rails and a second pair of flying rails and configured to generate a second flying rail voltage across the second pair of flying rails; and
the plurality of buck converters each configured to generate a regulated output voltage from the flying rail voltage comprises:
at least one buck converter coupled between the first pair of flying rails and configured to generate a first regulated output voltage from the first flying rail voltage; and
at least one buck converter coupled between the second pair of flying rails and configured to generate a second regulated output voltage from the second flying rail voltage.

9. The power converter of claim 8 further comprising a symmetric controller, the symmetric controller comprising:
a first controller configured to control the first charge pump and the at least one buck converter coupled between the first pair of flying rails; and
a second controller configured to control the second charge pump and the at least one buck converter coupled between the second pair of flying rails.

10. The power converter of claim 9 wherein at least one of the first and second controllers is configured to operate at least one corresponding buck converter in a continuous conduction mode.

11. The power converter of claim 9 wherein the first and second controllers are a single controller.

12. The power converter of claim 1, wherein the charge pump comprises:
a first charge pump switching device having first and second terminals, the first terminal of the first charge pump switching device being coupled to a first input voltage rail of the power converter;
a second charge pump switching device having first and second terminals, the second terminal of the second charge pump switching device being coupled to a second input voltage rail of the power converter;
a flying capacitor having a first flying capacitor terminal coupled to the second terminal of the first charge pump switching device and a second flying capacitor terminal coupled to the first terminal of the second charge pump switching device, wherein a voltage across the flying capacitor is the flying rail voltage.

13. The power converter of claim 1, wherein each of the plurality of buck converters comprises:
a first buck converter switching device having first and second terminals, the first terminal of the first buck converter switching device being coupled to the first flying capacitor terminal;
a second buck converter switching device having first and second terminals, the second terminal of the second buck converter switching device being coupled to the second flying capacitor terminal; and
an inductor having a first inductor terminal coupled to the second terminal of the first buck converters switching device and the first terminal of the second buck converter switching device and a second inductor terminal coupled to an output terminal.

14. A method of generating a plurality of output voltages from an input voltage, the method comprising:
using a charge pump to generate a flying rail voltage from the input voltage; and
using a plurality of buck converters to convert the flying rail voltage to the plurality of output voltages.

15. The method of claim 14 wherein using the charge pump to generate a flying rail voltage from the input voltage comprises operating a hysteretic controller to regulate the flying rail voltage by communicating a signal to the plurality of buck converters.

16. The method of claim 14 wherein using a plurality of buck converters to convert the flying rail voltage to the plurality of output voltages comprises operating the plurality of buck converters responsive to one or more signals received from an outer loop controller of the charge pump indicating whether the plurality of buck converters are to charge or discharge a capacitor of the charge pump.

17. The method of claim 14 wherein using a plurality of buck converters to convert the flying rail voltage to the plurality of output voltages comprises implementing a predictive control algorithm.

18. The method of claim 14 wherein:
using a charge pump to generate a flying rail voltage from the input voltage comprises:
using a first charge pump to generate a first flying rail voltage from the input voltage; and
using a second charge pump to generate a second flying rail voltage from the first flying rail voltage; and
using a plurality of buck converters to convert the flying rail voltage to the plurality of output voltages comprises:
using at least one buck converter to convert the first flying rail voltage to a first regulated output voltage; and
using at least one buck converter to convert the second flying rail voltage to a second regulated output voltage.

19. The method of claim 18 wherein at least one of using at least one buck converter to convert the first flying rail voltage to a first regulated output voltage and using at least one buck converter to convert the second flying rail voltage to a second regulated output voltage comprises operating a buck converter in continuous conduction mode.

20. A controller for a power converter having a charge pump and a plurality of buck converters, the charge pump being configured to receive an input voltage and generate therefrom a voltage across a flying rail and the plurality of buck converters each being configured to receive the flying rail voltage and generate a regulated output voltage therefrom, the controller comprising:
an outer control loop; and
a plurality of inner control loops in communication with the outer control loop each configured to control a plurality of switches coupled between the flying rails to generate a respective regulated output voltage and responsive to one or more signals received from the outer control loop indicating whether to draw power from or return power to the flying rails.

21. The controller of claim 20 wherein the outer loop configured to regulate the flying rail voltage comprises a hysteretic controller configured to generate the one or more signals.

22. A controller for a power converter having a first charge pump, at least one buck converter coupled to the output of the first charge pump, a second charge pump coupled to the output of the first charge pump, and at least one buck converter coupled to the output of the second charge pump, the controller comprising:
a first controller configured to operate the first charge pump and the at least one buck converter coupled to the output of the first charge pump to generate a regulated output voltage at an output of each of the at least one buck converters coupled to the output of the first charge pump; and
a second controller configured to operate the second charge pump and the at least one buck converter coupled to the output of the second charge pump to generate a regulated output voltage at an output of each of the at least one buck converters coupled to the output of the second charge pump.

23. The controller of claim 22 wherein at least one of the first and second controllers is configured to operate at least one corresponding buck converter in a continuous conduction mode.

24. The controller of claim 22 wherein the first and second controllers are a single controller.
